(19) United States
(12) Patent Application Publication
(10) Pub. No.: US 2023/0308143 A1
(43) Pub. Date: Sep. 28, 2023

(54) INFORMATION TRANSMISSION METHOD AND APPARATUS, COMMUNICATIONS DEVICE, AND STORAGE MEDIUM

(71) Applicant: VIVO MOBILE COMMUNICATION CO., LTD., Chang'an Dongguan (CN)

(72) Inventors: Pu YUAN, Chang'an Dongguan (CN); Dajie JIANG, Chang'an Dongguan (CN); Jin LIU, Chang'an Dongguan (CN); Yongchun BAI, Chang'an Dongguan (CN); Baolong CHEN, Chang'an Dongguan (CN)

(21) Appl. No.: 18/315,920

(22) Filed: May 11, 2023

Related U.S. Application Data
(63) Continuation of application No. PCT/CN2021/131838, filed on Nov. 19, 2021.

(30) Foreign Application Priority Data
Nov. 20, 2020 (CN) 202011314900.5

(51) Int. Cl. H04B 7/0417; H04B 7/06; H04B 7/08

(52) U.S. Cl. CPC H04B 7/0417; H04B 7/0617; H04B 7/0802

(57) ABSTRACT

This application discloses an information transmission method and apparatus, a device, and a storage medium, and pertains to the communications field. The method is applied to a communications device and includes: obtaining channel quality of a plurality of antennas; determining an antenna working mode according to the channel quality; and performing information transmission by using the antenna working mode, where the antenna working mode includes a MIMO mode, an FTN mode, or a MIMO-FTN mode in which an FTN manner is used for a same intra-antenna port group in the plurality of antennas and a MIMO manner is used for different inter-antenna port groups, where each antenna port group includes at least one antenna.

### CROSS-REFERENCE TO RELATED APPLICATIONS

This application is a continuation of International Application No. PCT/CN2021/131838, filed on Nov. 19, 2021, which claims priority to Chinese Pat. Application No. 202011314900.5, filed on Nov. 20, 2020 in China, which are incorporated herein by reference in their entireties.

### TECHNICAL FIELD

This application pertains to the field of communications technologies, and particularly relates to an information transmission method and apparatus, a communications device, and a storage medium.

### BACKGROUND

In a communications system, to obtain an additional diversity gain or improve spectral efficiency, a multiple-input multiple-output-orthogonal frequency division multiplexing (MIMO-OFDM) scheme may be adopted. Transmit signals on different transmit antennas in a multiple-input multiple-output (MIMO) scheme are completely synchronous, that is, when transmit signals of different antennas are superposed, peaks of signal waveforms are superposed, and troughs are superposed. MIMO can obtain a considerable diversity gain to ensure transmission reliability. However, multi-stream MIMO is restricted by an error vector magnitude (EVM) of higher-order modulation, and consequently improvement of spectral efficiency is restricted in some scenarios.

### SUMMARY

According to a first aspect of this application, an information transmission method is provided and is applied to a communications device. The method includes: obtaining channel quality of a plurality of antennas; determining an antenna working mode according to the channel quality; and performing information transmission by using the antenna working mode, where the antenna working mode includes a MIMO mode in which the plurality of antennas all work in a multiple-input multiple-output (MIMO) manner, an FTN mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, where each antenna port group includes at least one antenna.

According to a second aspect of this application, an information transmission apparatus is provided and is applied to a communications device. The apparatus includes: a first obtaining module, configured to obtain channel quality of a plurality of antennas; a first determining module, configured to determine an antenna working mode according to the channel quality; and a first transmission module, configured to perform information transmission by using the antenna working mode, where the antenna working mode includes a MIMO mode in which the plurality of antennas all work in a multiple-input multiple-output (MIMO) manner, an FTN mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, where each antenna port group includes at least one antenna.

According to a third aspect of this application, a communications device is provided. The communications device includes a processor, a memory, and a program or an instruction that is stored in the memory and that can be run on the processor, where when the program or the instruction is executed by the processor, the steps of the method in the first aspect are implemented.

According to a fourth aspect of this application, a readable storage medium is provided. The readable storage medium stores a program or an instruction, and when the program or the instruction is executed by a processor, the steps of the method in the first aspect are implemented.

According to a fifth aspect of this application, a chip is provided. The chip includes a processor and a communications interface, the communications interface is coupled to the processor, and the processor is configured to run a program or an instruction of a communications device to implement the method in the first aspect.

### BRIEF DESCRIPTION OF DRAWINGS

FIG. 1 is a block diagram of a wireless communications system according to an embodiment of this application;

FIG. 2 is a schematic diagram of comparison between a signal that has no time domain overlapping and a signal that has time domain overlapping according to an embodiment of this application;

FIG. 3 is a schematic flowchart of an information transmission method according to an embodiment of this application;

FIG. 4 is a schematic diagram of generating an FTN/OVTDM symbol by a multi-antenna system according to an embodiment of this application;

FIG. 5 is a schematic diagram of transmission in a MIMO-FTN mode according to an embodiment of this application;

FIG. 6 is a schematic diagram of an antenna working mode determining method according to an embodiment of this application;

FIG. 7 is a schematic diagram of downlink measurement according to an embodiment of this application;

FIG. 8 is a schematic diagram of uplink measurement according to an embodiment of this application;

FIG. 9 is a schematic structural diagram of an information transmission apparatus according to an embodiment of this application;

FIG. 10 is a schematic structural diagram of a communications device according to an embodiment of this application;

FIG. 11 is a schematic structural diagram of hardware of a network side device according to an embodiment of this application; and

FIG. 12 is a schematic structural diagram of hardware of a terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first”, “second”, and the like are intended to distinguish between similar objects but do not describe a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are used in most of the following descriptions, but these technologies can also be applied to an application other than an NR system application, for example, a 6^{th} generation (6G) communications system.

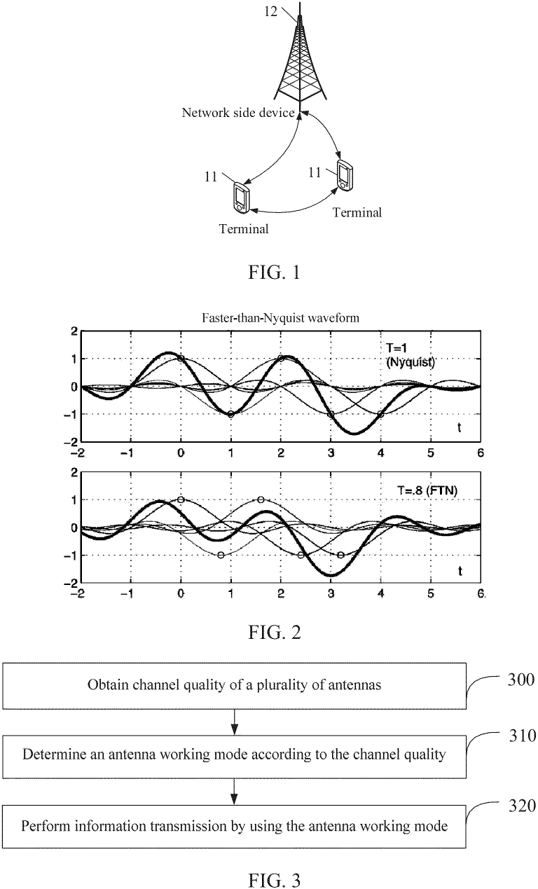

FIG. 1 is a block diagram of a wireless communications system according to an embodiment of this application. The wireless communications system includes a terminal 11 and a network side device 12. The terminal 11 may also be referred to as a terminal device or user equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), a wearable device, vehicle user equipment (VUE), or pedestrian user equipment (PUE). The wearable device includes a bracelet, a headset, glasses, and the like. It should be noted that a specific type of the terminal 11 is not limited in the embodiments of this application. The network side device 12 may be a base station or a core network. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a WLAN access point, a Wi-Fi node, a transmission reception point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

To describe the embodiments of this application more fully, the following content is first described:

### 1. Mimo

In a MIMO system, a transmit side and a receive side communicate with each other by using a plurality of antennas that can simultaneously work. In the MIMO systems, complex signal processing technologies are usually used to significantly enhance reliability, a transmission range, and a throughput. A transmitter simultaneously sends a plurality of radio frequency signals by using these technologies, and then a receiver recovers information from these signals.

A common goal of different MIMO modes is to obtain an additional diversity gain or improve spectral efficiency by using a known spatial correlation. For example, MIMO modes in a Long Term Evolution (LTE) protocol mainly include the following:

### Mode 1: Single-Antenna Working Mode

This is an antenna working mode of a traditional wireless standard.

### Mode 2: Open-Loop Transmit Diversity

In a complex conjugate mathematical method, spatial channels that are orthogonal to each other are formed on a plurality of antennas, and a same data stream is sent, thereby improving transmission reliability.

### Mode 3: Open-Loop Spatial Multiplexing

A “multipath effect” is artificially created on different antennas. One antenna is used for normal transmission, and a phase offset is introduced on another antenna. Transmission relationships of a plurality of antennas form a complex matrix, and different data streams are transmitted in parallel. This complex matrix is randomly selected at a transmit end and a feedback result of a receive end is not relied upon, that is, open-loop spatial multiplexing.

### Mode 4: Closed-Loop Spatial Multiplexing

When transmitting a plurality of data streams in parallel, a transmit end selects, according to a feedback result of channel estimation, a complex matrix that creates a “multipath effect”, that is, closed-loop spatial multiplexing.

### Mode 5:Multi-User-Multiple-Input Multiple-Output (MU-MIMO)

A plurality of data streams transmitted in parallel are implemented by a combination of a plurality of pieces of user equipment (UE), that is, multi-user spatial multiplexing MU-MIMO (Multi User MIMO).

### Mode 6: Closed-Loop Transmit Diversity of Rank=1

In a special example of closed-loop spatial multiplexing, only one data stream is transmitted, that is, a rank of a spatial channel is 1. This working mode is used to improve transmission reliability, and is actually a transmit diversity manner.

### Mode 7: Beamforming

When a plurality of antennas work cooperatively, different phase offset schemes are calculated in real time according to channel conditions of a base station and UE, and a beam pointing to specific UE is formed by using a phase interference superposition principle between antennas.

In current working modes 3 to 6 of the MIMO system, different antennas are used to send different data streams, to improve spectrum efficiency. An upper limit of the number of streams in MIMO multi-stream transmission is determined by the number of antennas. Based on this, when channel quality is relatively good or a signal-to-noise ratio (SNR) is relatively large, spectrum efficiency can be further improved in the system through higher-order modulation. However, due to a limitation of a minimum EVM of the receiver, as a modulation order increases, spectral efficiency of the system is reduced by a marginal effect. Therefore, when the SNR is large enough, an faster-than-Nyquist/overlapped time division multiplexing (FTN/OVTDM) technology is introduced into a MIMO multi-antenna system, and signal delay superposition sending is performed by using a plurality of antennas, thereby further improving spectrum efficiency.

In a conventional single-antenna system, an FTN/OVTDM signal is generated by passing a sampled signal through a molding filter. On the premise that sampling accuracy of design of the molding filter is determined, the larger number of superposition layers leads to a higher required signal over-sampling rate. Higher-order superposition is challenging to hardware design. In the multi-antenna system, signals are sent at different time delays by using different antenna elements/ports, and FTN/OVTDM signals are superposed on an air interface. By using an existing multi-antenna design in the MIMO system, faster-than-Nyquist sampling transmission is implemented, thereby reducing complexity and hardware costs of a baseband design.

### 2. Faster-Than-Nyquist Transmission, That is, Faster-Than-Nyquist Signaling

FTN/OVTDM is a signal processing method in which an appropriate amount of Inter-Symbol Interference (ISI) and/or Inter-Carrier Interference (ICI) is artificially introduced by performing shift superposition processing (also referred to as waveform coding) on a transmit signal, to accelerate an element sending rate, that is, increase the number of symbols sent per hertz per second (Hz*s). A full name of FTN is faster-than-Nyquist, that is, faster-than-Nyquist. Overlapped X Division Multiplexing(OVXDM), (X-domain overlapped multiplexing, X represents any domain, time T, space S, frequency F, or hybrid H) includes overlapped time division multiplexing(OVTDM), overlapped frequency domain multiplexing system(OVFDM),overlapped code division multiplexing(OVCDM), and a combination of OVTDM and OVFDM, which is fully referred to as overlapped X-domain multiplexing, that is, X-domain overlapped multiplexing, and may be referred to as FTN (Faster Than Nyquist, multi-carrier faster-than-Nyquist). In addition, the introduced ISI and ICI increase decoding complexity, and may result in improvement of a bit error rate. However, an advanced decoding algorithm can be used to suppress a negative effect caused by improvement of the bit error rate, and in a comprehensive view, a channel capacity can still be improved by using the method for accelerating an element sending rate. An expression is as follows:

$$s \left(t\right) = x \left(t\right) ∗ h \left(t\right) = {\sum }_{n}^{N} {\sum }_{k}^{K} {a}_{k , n} h \left(t - n {T}_{Δ}\right) {e}^{j 2 π t k {f}_{Δ}} ,$$

where T_{Δ} = τT and τ ∈ (0,1), where τ is a time domain overlapping coefficient. In particular,

$$τ = \frac{1}{N}$$

in OVXDM, and therefore

$${T}_{Δ} = \frac{T}{N} . {f}_{Δ} = \frac{ζ}{T} , ζ ∈ \left(0 , 1\right) ,$$

where ζ is a frequency domain overlapping coefficient. In particular,

$$ζ = \frac{1}{K}$$

in OVXDM, and therefore

$${f}_{Δ} = \frac{1}{K T} .$$

FIG. 2 is a schematic diagram of comparison between a signal that has no time domain overlapping and a signal that has time domain overlapping according to an embodiment of this application. As shown in FIG. 2, ISI is produced. When T=0.8, that is, a time domain waveform overlapping coefficient τ=0.8, a pulse waveform amplitude of a processed signal that carries information about another sampling point is not zero at a moment at which each sampling point is located. Therefore, ISI is produced.

Assuming that an impulse response function of a multipath channel is h_{CH}(t), a signal passing through a channel may be expressed as follows:

$${s}^{′} \left(t\right) = x \left(t\right) ∗ h \left(t\right) ∗ {h}_{C H} \left(t\right) ≜ {\sum }_{\tilde{n}}^{\tilde{N}} {\sum }_{\tilde{k}}^{\tilde{K}} {a}_{\tilde{n} , \tilde{k}} h \left(t - {T}_{Δ}^{\tilde{n}}\right) {e}^{j 2 π t {f}_{Δ}^{\tilde{k}}} \# \left(1\right) ,$$

where

$${T}_{Δ}^{\tilde{n}} \leq n {T}_{Δ} , {f}_{Δ}^{\tilde{k}} \leq k {f}_{Δ} , N \leq \tilde{N} , K \leq \tilde{K} .$$

The FTN/OVTDM signal is mainly generated in two manners: (1) In the single-antenna system, the signal may be generated equivalently through signal oversampling and shaping filtering, and an effect is similar to a convolutional encoder at a modulation level. (2) In the multi-antenna system, the signal may be generated in a way that is closer to its physical meaning, that is, each antenna element/port for multi-antenna controlling successively transmits signals with a delay of T_{Δ} according to an established shift superposition principle, and signals sent by different antenna elements/ports with different delays are superposed at an air interface, and ISI is introduced between sampling points of the signals to form the FTN/OVTDM signal.

Faster-than-Nyquist transmission is a new signal processing technology that is currently considered to be capable of breaking through a Nyquist sampling rate and further approximating a physical limit of a channel capacity. A derivation technology thereof is OVXDM. In the OVXDM/FTN technology, ISI and/or ICI are/is artificially introduced based on a waveform coding theory in time domain/frequency domain, thereby improving an element sending rate and increasing an equivalent channel capacity. However, a waveform-coded signal poses a higher requirement on performance of the receiver, which increases complexity of the decoding algorithm and power consumption of hardware. Generally, when a time-frequency domain overlapping coefficient is larger during waveform coding, that is, ISI and ICI that are artificially introduced are more serious, more states need to be determined on the receiver side, and complexity of a receive algorithm is higher.

In a complex electromagnetic wave transmission environment in a city, because a large amount of scattering, reflection, and refraction planes exist, radio signals arrive at a receive antenna at different moments on different paths, that is, a multipath effect of transmission is caused by signals on different paths. When symbols before and after a transmit signal arrive simultaneously on different paths, or when a next symbol arrives within delay extension of a previous symbol, ISI is produced. Similarly, in frequency domain, because of a frequency offset effect, a Doppler effect, or the like, each subcarrier of a signal produces different degrees of frequency offset, thereby causing overlapping of subcarriers that may otherwise be orthogonal, that is, ICI. The ISI/ICI generated in a signal transmission process is superposed with ISI/ICI introduced through waveform coding during sending, which imposes a higher requirement on a decoding capability of the receiver. More complex receiver algorithms may be used to combat fading channels. For example, a channel pre-equalization method and an iterative algorithm for joint channel decoding are used. In actual application, an actual system is restricted by conditions such as costs and power consumption, and an ideal receiver usually cannot be used. Therefore, complexity of the decoding algorithm is restricted, and when the ISI/ICI exceeds a specific threshold, correct decoding cannot be performed. In addition, when decoding complexity of the receiver increases, energy consumption also increases, which is not conducive to energy saving and consumption reduction of a terminal.

Therefore, obviously, the FTN/OVTDM system is not superior to a traditional MIMO system in all scenarios.

Therefore, a main idea of the embodiments of this application is as follows: A working mode of a multi-antenna system may be flexibly adjusted by using prior information of a radio channel, a channel measurement result, and the like, so that the multi-antenna system can be flexibly switched between the FTN/OVTDM mode and the traditional MIMO working mode. In this way, a receiver can track a time-varying characteristic of a fading channel, and always remain in an optimal working state.

With reference to the accompanying drawings, an information transmission method and apparatus provided in the embodiments of this application are described in detail by using specific embodiments and application scenarios.

FIG. 3 is a schematic flowchart of an information transmission method according to an embodiment of this application. The method is applied to a communications device. As shown in FIG. 3, the method includes the following steps:

Step 300: Obtain channel quality of a plurality of antennas.

Step 310: Determine an antenna working mode according to the channel quality.

Step 320: Perform information transmission by using the antenna working mode.

The antenna working mode includes a MIMO mode in which the plurality of antennas all work in a multiple-input multiple-output (MIMO) manner, an FTN mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, where each antenna port group includes at least one antenna.

In some embodiments, during MIMO transmission, spatial correlation between a plurality of antennas is utilized, and an extra gain is provided through digital domain beamforming (that is, MIMO precoding performed according to a channel characteristic) at a transmit end. The extra gain is essentially a gain obtained by utilizing additional spatial degrees of freedom provided by the plurality of antennas, which may be referred to as a MIMO gain.

However, an FTN signal utilizes a delay superposition characteristic between signals sent by different antennas, to achieve an effect of sending more information bits within a same transmit time interval (TTI). For example, when the number K of overlapping layers is 2, it is equivalent to that bits to be sent within 2T are sent within T through Nyquist transmission, to obtain an extra gain. The essence of this is to utilize a signal waveform superposition rule known at a receive end and a transmit end to increase additional degrees of coding freedom, so that information can be sent after being compressed according to a coding rule to improve spectrum efficiency, which may be referred to as an FTN gain.

In a MIMO working mode, transmit signals on different transmit antennas are completely synchronous. That is, when transmit signals of different antennas are superposed, peaks of signal waveforms are superposed, and troughs are superposed. Through measurement on MIMO channel information, an appropriate precoding matrix is selected to obtain additional benefits of a multi-antenna system. For example, a diversity gain is implemented through space-time coding, or multi-stream transmission is implemented through precoding, thereby improving spectrum efficiency.

In some embodiments, in this embodiment, the multi-antenna system in MIMO may be seamlessly switched in two or three modes.

For example, in a low signal-to-noise ratio (SNR), a considerable diversity gain may be obtained in the MIMO mode, thereby ensuring transmission reliability. In a high SNR, multi-stream MIMO is restricted by an EVM of higher-order modulation, and consequently improvement of spectral efficiency is restricted. In this case, the FTN mode may be used. Therefore, the transmit end and/or the receive end may trigger switching of a working mode through measurement and feedback on channel state information.

In some embodiments, to flexibly adjust a working mode of the multi-antenna system by using prior information of a radio channel and a channel measurement result or the like, the multi-antenna system can be flexibly switched between a plurality of working modes, and can be switched to the FTN mode, the MIMO mode, or the MIMO-FTN mode. Through flexible switching between the plurality of working modes, a signal sending mode is optimized according to a change in a channel state. Therefore, channel quality may be obtained through measurement and feedback on channel quality of a plurality of antennas, and an antenna working mode is determined based on the channel quality. Switching is triggered by the transmit end and/or the receive end. Finally, information transmission is completed based on the determined antenna working mode, and a procedure and signaling are protected.

It can be understood that the multi-antenna system in this embodiment may be switched to the following working modes:

Mode 1: MIMO mode. In this mode, an antenna performs precoding transmission in a conventional manner by presetting different coefficients on each antenna channel, to implement digital beamforming.

(2) Mode 2: FTN mode. FIG. 4 is a schematic diagram of generating an FTN/OVTDM symbol by a multi-antenna system according to an embodiment of this application. As shown in FIG. 4, in this mode, an antenna works in an FTN manner. That is, each antenna channel sends a signal at a specified time interval, and signals are superposed on an air interface to form an FTN signal.

(3) Mode 3: MIMO-FTN mode. In the MIMO-FTN mode, some antennas form a set, namely, an antenna port group, signals of antennas in the group are superposed to form an FTN signal, and information is transmitted between antenna port groups based on the MIMO working mode.

It can be understood that the antenna port group may be a group in a unit of an antenna, that is, a plurality of antennas may be grouped to obtain the antenna port group.

The antenna port group may be alternatively a group in a unit of an antenna channel, that is, a plurality of antenna channels may be grouped to obtain the antenna port group.

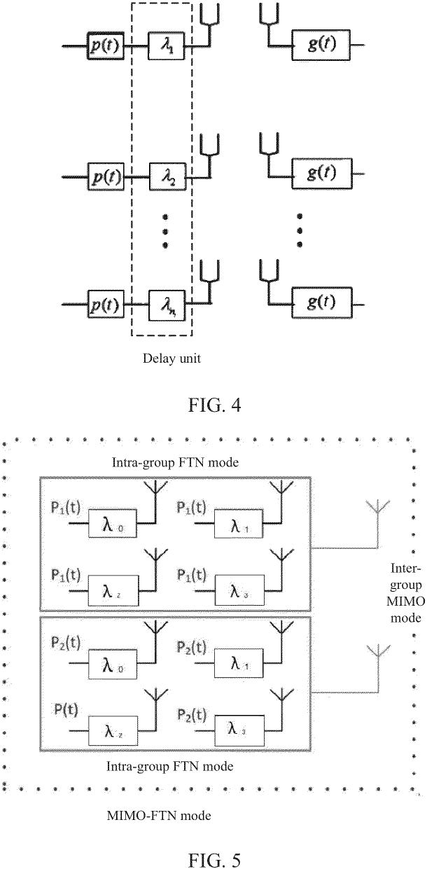

FIG. 5 is a schematic diagram of transmission in a MIMO-FTN hybrid working mode according to an embodiment of this application. Taking FIG. 5 as an example, there are a total of eight antennas in a multi-antenna system in FIG. 5. Antennas in each solid-line frame are classified into one group, which is referred to as an antenna port group. Information about antennas in an antenna port group 1 is transmitted by using different delays [λ₀, λ₁, λ₂, and λ₃], and information about antennas in an antenna port group 2 is transmitted by using different delays [λ₀, λ₁, λ₂, and λ₃]. Based on this, information about the antenna port group 1 and the antenna port group 2 is transmitted based on the MIMO working mode.

In this embodiment of this application, the multi-antenna system in MIMO can work in two states: conventional MIMO and FTN/OVTDM. In a protocol, at least one MIMO mode needs to be added, and may be referred to as the FTN mode in this application, and correspondingly an FTN/OVTDM signal is transmitted by using a plurality of antennas. For ease of description, a conventional MIMO mode may be referred to as the MIMO mode.

In this embodiment of this application, an uplink and a downlink are defined as follows: The uplink is from a terminal side such as user equipment to a network side such as a base station, and the downlink is from a network side such as a base station to a terminal side such as user equipment.

It can be understood that, in addition to being applicable to uplink and downlink information transmission, this embodiment may be further applicable to sidelink information transmission.

In some embodiments, the communications device may be a network side device, for example, a base station. In this case, the transmit end is a network side, the receive end is a terminal side, and corresponding transmitted information is downlink information.

In some embodiments, the communications device may be a terminal, for example, UE. In this case, the transmit end is a terminal side, the receive end is a network side, and corresponding transmitted information is uplink information.

In some embodiments, the communications device may be a terminal, for example, UE, and a communications peer end is also a terminal. In this case, the transmit end is a terminal, the receive end is a terminal, and corresponding transmitted information is sidelink information.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

In some embodiments, the determining an antenna working mode according to the channel quality includes at least one of the following:
in a case that the channel quality is less than or equal to a first threshold, determining that the antenna working mode is the MIMO mode;
in a case that the channel quality is greater than or equal to a second threshold, determine that the antenna working mode is the FTN mode; or
in a case that the channel quality is greater than the first threshold and less than the second threshold, determining that the antenna working mode is the MIMO-FTN mode.

In some embodiments, a throughput advantage of an FTN/OVTDM system compared with a conventional OFDM system mainly lies in a high-SNR area. In the high-SNR area, a degree of influence of noise on a received signal is relatively small, a receiver is prone to correctly perform decoding according to a known constraint relationship of inter-symbol coding of FTN/OVTDM, and a bit error rate is very low. In a low-SNR area, a degree of influence of noise on a received signal is relatively large, which destroys the constraint relationship of inter-symbol coding, and therefore a bit error rate is relatively high and is less than that in the conventional OFDM system.

In some embodiments, the antenna working mode may be determined based on a signal to interference plus noise ratio SINR in channel state information.

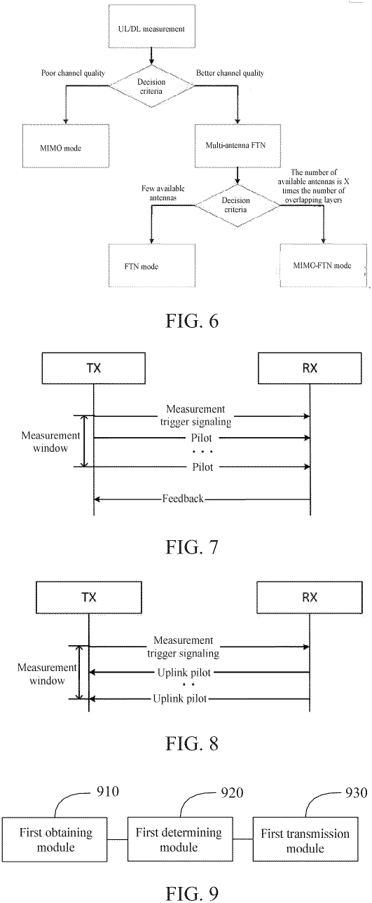

FIG. 6 is a schematic diagram of a method for determining an antenna working mode according to an embodiment of this application. As shown in FIG. 6, for an antenna set such as an antenna port group, when a channel state is good, that is, the channel quality is greater than or equal to the second threshold, for example, an SNR of a received signal is greater than the second threshold, and therefore when an FTN gain is greater than a MIMO gain, the antenna working mode may be switched to the FTN mode. On the contrary, when the channel state is poor, the channel quality is less than or equal to the first threshold, and the FTN gain is less than the MIMO gain, the antenna working mode may be switched to a MIMO beamforming mode. If the channel quality is greater than the first threshold and less than the second threshold, the antenna working mode may be switched to the MIMO-FTN mode. Further, an antenna grouping manner and a coordinated working mode between antenna groups may be determined according to the number of available antennas and the number of required FTN overlapping layers. For example, when the number of antennas is many times the number of FTN overlapping layers, it may be determined that the antenna working mode is the MIMO-FTN mode.

In some embodiments, the first threshold and the second threshold may be pre-determined, may be configured on a network, or may be stipulated in the protocol.

In this embodiment of this application, according to different channel conditions, when received SNR≥Thh (the second threshold), a larger gain can be obtained through FTN. When received SNR<Th1 (the first threshold), an effect of traditional MIMO is better. When Th1<SNR<Thh, a trade-off between a MIMO gain and an FTN gain is obtained in a hybrid mode, thereby further implementing dynamic optimization of spectrum efficiency for the SNR.

In some embodiments, after the determining an antenna working mode according to the channel quality, the method further includes: switching the antenna working mode according to updated channel quality; and performing information transmission by using a switched antenna working mode.

In some embodiments, to implement adaptive switching of the working mode in the multi-antenna system according to the channel quality, after the antenna working mode is determined, an updated information transmission situation may be further monitored, and the antenna working mode to be switched to is determined according to the information transmission situation.

For example, when the current antenna working mode is the FTN mode, it may be determined that the current antenna working mode needs to be switched in a case that it is determined that continuous multiple information transmissions do not meet a transmission condition. It may be determined, according to updated channel quality, that the antenna working mode may be switched to the MIMO-FTN mode to adapt to the antenna working mode of the current channel quality, so that the antenna working mode can be switched.

It can be understood that the updated channel quality may be channel quality obtained by means of measurement after it is determined that the antenna working mode needs to be switched, or may be a combined value or an average value of channel quality obtained by means of multiple channel measurements after the antenna working mode is determined.

In some embodiments, after the switched antenna working mode is determined and switching is performed, information transmission continues.

It can be understood that, in this embodiment of this application, when it is determined whether information transmission meets the condition, transmission of one or more data blocks may be used as a unit for determining.

In some embodiments, the channel quality is determined according to a first channel quality parameter, and the first channel quality parameter includes at least one of a signal-to-noise ratio SNR, a signal to interference plus noise ratio SINR, reference signal received power RSRP, or reference signal received quality RSRQ.

In some embodiments, the channel quality is determined according to the first channel quality parameter, and may include: a SNR, a signal to interference plus noise ratio (SINR), reference signal received power (RSRP), reference signal received quality (RSRQ), and the like that may be obtained through pilot measurement, and may further include a Doppler frequency offset, a residual frequency offset (a frequency offset after frequency offset correction), the multipath number, and a relative speed. These parameters may directly affect a frequency offset, ISI, and ICI of a signal, or may be indirectly reflected in a bit error rate.

It can be understood that the relative speed is a radial speed between the transmit end and the receive end.

In some embodiments, when the communications device is a terminal, the obtaining channel quality of a plurality of antennas includes: receiving a downlink reference signal by using the plurality of antennas; and measuring the downlink reference signal to obtain the channel quality.

In some embodiments, when the communications device is a terminal and the communications peer end is a network side device, this transmission is uplink transmission. It can be understood that downlink measurement may be performed in an uplink transmission scenario based on channel reciprocity.

In some embodiments, downlink reference information sent by the network side device may be received by using the plurality of antennas, and the downlink reference information is measured to obtain downlink channel quality as reference for uplink channel quality.

It can be understood that, in this embodiment of this application, in an uplink transmission scenario, uplink measurement may be further performed, and a base station measures an uplink channel and notifies the terminal of channel quality.

In some embodiments, when the communications device is a terminal and a communications peer end is a terminal, the obtaining channel quality of a plurality of antennas includes: sending a sidelink reference signal by using the plurality of antennas; and receiving channel quality fed back by the communications peer end, where the channel quality is obtained by the communications peer end by means of measurement according to the sidelink reference signal.

In some embodiments, when the communications device is a terminal, and the communications peer end may be a terminal, this transmission is sidelink transmission, and channel measurement may also be performed.

In some embodiments, the sidelink reference signal may be sent to the terminal of the communications peer end. After receiving the sidelink reference signal, the communications peer end may measure the sidelink reference signal to obtain the channel quality, and notify the terminal at the transmit end, so that the terminal at the transmit end can receive the channel quality fed back by the communications peer end.

In some embodiments, when the communications device is a network side device, the obtaining channel quality of a plurality of antennas includes:
sending a downlink reference signal by using the plurality of antennas; and
receiving channel state information (CSI) fed back by a terminal, to obtain the channel quality, where the CSI is obtained by the terminal by means of measurement according to the downlink reference signal.

In some embodiments, when the communications device is a network side device and the communications peer end is a terminal, this transmission is downlink transmission, and downlink measurement may be performed.

In a downlink measurement scenario, the network side device sends the downlink reference signal, the terminal measures a channel according to the downlink reference signal, and sends a feedback message to the network side. The network side may receive the channel state information CSI fed back by the terminal.

In some embodiments, when the communications device is a network side device, the obtaining channel quality of a plurality of antennas includes:
receiving an uplink reference signal by using the plurality of antennas; and
measuring the uplink reference signal to obtain the channel quality.

In some embodiments, when the communications device is a network side device and a communications peer end is a terminal, this transmission is downlink transmission, and uplink measurement may be further performed in a downlink transmission scenario based on channel reciprocity.

In an uplink measurement scenario, the terminal side sends the uplink reference signal, and the network side measures a channel according to the uplink reference signal to obtain the channel quality.

It can be understood that, uplink measurement is performed in the downlink transmission scenario, or a premise of preforming downlink measurement is the assumption of channel reciprocity in the uplink transmission scenario. That is, a channel from the transmit end to the receive end is similar to a channel from the receive end to the transmit end, for example, this manner may be used in a time division duplexing (TDD) scenario.

It can be understood that channel quality obtained by means of measurement may be used to determine the antenna working mode, and determine the number of overlapping layers in FTN and the like.

In some embodiments, when the antenna working mode is the MIMO-FTN mode, the method further includes:
determining the number of overlapping layers when an FTN manner is used for an intra-antenna port group; and
determining a MIMO target working mode when a MIMO manner is used for inter-antenna port groups; where
the performing information transmission by using the antenna working mode includes: performing information transmission according to the MIMO target working mode and the number of overlapping layers.

In some embodiments, in the MIMO-FTN mode, some antennas form a set, namely, an antenna port group, signals of antennas in the group are superposed in an FTN manner to form an FTN signal, and processing is performed between antenna port groups based on the MIMO target working mode to obtain MIMO-FTN information. Therefore, before information transmission, the number of overlapping layers in the antenna port group when an FTN manner is used for the intra-antenna port group and the MIMO target working mode when a MIMO manner is used for the inter-antenna port groups may be first determined.

In some embodiments, the number of overlapping layers may be used to represent an FTN/OVTDM signal feature.

In some embodiments, an antenna port group may be considered as a virtual antenna port. Therefore, when information transmission is performed according to the MIMO target working mode and the number of overlapping layers, MIMO transmission may be performed on FTN information of the virtual antenna port, and the MIMO target working mode may be further determined based on measurement information of the antenna port group.

In some embodiments, the MIMO target working mode may be determined according to a current system condition of the multi-antenna system and a radio environment situation.

In some embodiments, in a case that link quality is relatively good, a working mode with relatively high multiplexing degree is used. In a case that link quality is relatively poor, the number of to-be-multiplexed data streams needs to be reduced, or even no multiplexing is required, spatial diversity or beamforming may be selected.

In some embodiments, the MIMO target working mode may be further determined according to a transmission requirement. For example, if information transmission efficiency needs to be further improved, the open-loop spatial multiplexing mode may be selected, and if information transmission reliability needs to be further improved, the open-loop transmit diversity mode may be selected.

The MIMO target working mode may be any one of the following:
Mode 1: Single-antenna working mode
Mode 2: Open-loop transmit diversity
Mode 3: Open-loop spatial multiplexing
Mode 4: Closed-loop spatial multiplexing
Mode 5: MU-MIMO
Mode 6: Closed-loop transmit diversity of Rank=1
Mode 7: Beamforming (Beamforming)

In some embodiments, after the MIMO target working mode is determined, MIMO transmission may be performed based on the MIMO target working mode for FTN information of at least two antenna groups.

In some embodiments, the determining the number of overlapping layers when an FTN manner is used for an intra-antenna port group includes:

determining the number of overlapping layers based on the channel quality.

In some embodiments, the number of overlapping layers may be determined based on the channel quality.

In some embodiments, in this embodiment of this application, when information is superposed by using a multi-antenna delay, K antennas may be used to generate information with an overlapping coefficient of

$$\frac{1}{K} ,$$

which is equivalent to OVTDM information with the number K of overlapping layers.

In some embodiments, the channel quality is determined according to a second channel quality parameter, and the second channel quality parameter includes at least one of the following: an SINR, RSRP, the multipath number, a relative speed, a Doppler frequency shift, a residual frequency offset after frequency offset correction, or a bit error rate.

In some embodiments, when the number of overlapping layers is determined based on the channel quality, determining methods may include but are not limited to the following:

i. Being determined according to the SINR and the received reference signal power RSRP. The protocol may specify a table in which a group of SINRs correspond to the numbers of overlapping layers one by one, and the number of overlapping layers is determined by measuring the SINRs through table lookup. The correspondence in the table may be obtained from experience of a simulation test.

ii. Being determined according to the SINR, the RSRP, the multipath number, and the relative speed.

iii. Being determined the SINR, the RSRP, the Doppler frequency shift or the residual frequency offset, and the multipath number.

iv. Being determined according to the bit error rate, the RSRP, the multipath number, and the relative speed.

v. Being determined according to the bit error rate, the RSRP, the Doppler frequency shift or the residual frequency offset, and the relative speed.

In some embodiments, in a case that the MIMO target working mode is a beamforming MIMO mode, the method further includes: determining a precoding matrix indicator PMI (Precoding Matrix Indicator, PMI) of the antenna port group according to the channel measurement information of the antenna port group, where the performing information transmission according to the MIMO target working mode and the number of overlapping layers includes: performing information transmission according to the PMI used in the beamforming MIMO mode and the number of overlapping layers.

In some embodiments, in a case that the MIMO target working mode is beamforming, in the MIMO-FTN mode, intra-group information is superposed to form FTN information, and MIMO precoding is performed based on precoding matrix indicator PMI between groups for digital beamforming to obtain MIMO-FTN information. Therefore, the precoding matrix indicator PMI of the antenna port group may be first determined according to the channel measurement information of the antenna port group.

In some embodiments, the determining a precoding matrix indicator PMI when a MIMO manner is used for inter-antenna port groups includes:
obtaining channel measurement information of an antenna port group; and
determining a precoding matrix indicator PMI of the antenna port group according to the channel measurement information of the antenna port group.

In some embodiments, for information between a plurality of antenna port groups, digital beamforming may be performed based on a target precoding matrix.

In some embodiments, the PMI may be first determined based on the channel measurement information of the antenna port group, and the precoding matrix is determined based on the PMI. Therefore, the precoding matrix indicator PMI may be first determined.

In some embodiments, after antennas are grouped to obtain an antenna port group, channel measurement and feedback may be performed in a unit of antenna port group, to obtain channel measurement information of the antenna port group, and further a precoding matrix used for each group is determined based on a PMI in the channel measurement information of the antenna port group.

In some embodiments, after the channel measurement information of the antenna port group is obtained, a proper precoding matrix may be selected by using the PMI as required and allocated to each antenna port to implement MIMO precoding transmission.

It can be understood that the precoding matrix may be obtained by performing a real-time operation, or may be selected from a preset codebook.

In some embodiments, when the communications device is a network side device, the determining a precoding matrix indicator PMI of the antenna port group according to the channel measurement information of the antenna port group includes: sending a downlink reference signal and measurement trigger signaling to a terminal by using the antenna port group; receiving channel state information CSI fed back by the terminal based on the measurement trigger signaling; and determining the precoding matrix indicator PMI of the antenna port group according to CSI of the antenna port group, where the CSI is obtained by the terminal by means of measurement according to the downlink reference signal, and the measurement trigger signaling includes the number of antenna port groups.

In some embodiments, when channel measurement and feedback are performed in a unit of antenna port group, measurement may be performed after the measurement trigger signaling sent by the transmit end is obtained.

It can be understood that the measurement trigger signaling may include the number of antenna port groups, so that the receive end can determine CSI of how many groups of channels need to be measured.

It can be understood that channel measurement performed in a unit of antenna port groups may be completed by means of uplink measurement or downlink measurement.

In some embodiments, when the communications device is a network side device and the communications peer end is a terminal, this transmission is downlink transmission, and downlink measurement may be performed.

FIG. 7 is a schematic diagram of downlink measurement according to an embodiment of this application. As shown in FIG. 7, in a downlink measurement scenario, a network side device sends a downlink reference signal and measurement trigger signaling. A terminal measures a channel of an antenna port group according to the downlink reference signal, and sends a feedback message to the network side. The network side may receive channel state information CSI fed back by the terminal.

In some embodiments, when the communications device is a network side device, the obtaining channel measurement information of an antenna port group includes:
sending measurement trigger signaling to a terminal by using the antenna port group;
receiving an uplink reference signal sent by the terminal based on the measurement trigger signaling; and
measuring the uplink reference signal to obtain the channel measurement information, where
the measurement trigger signaling includes the number of antenna port groups.

In some embodiments, when the communications device is a network side device and the communications peer end is a terminal, this transmission is downlink transmission, and uplink measurement may be further performed in a downlink transmission scenario based on channel reciprocity in a unit of antenna port group.

FIG. 8 is a schematic diagram of uplink measurement according to an embodiment of this application. As shown in FIG. 8, in an uplink measurement scenario, a network side device sends measurement trigger signaling, and after receiving the measurement trigger signaling, a terminal sends an uplink reference signal in a unit of antenna port group. The network side device measures a channel according to the uplink reference signal to obtain the channel measurement information.

It can be understood that the measurement trigger signaling may include the number of antenna port groups, so that the receive end can determine channel measurement information of how many groups of channels need to be measured.

It can be understood that, uplink measurement is performed in the downlink transmission scenario, or a premise of preforming downlink measurement is the assumption of channel reciprocity in the uplink transmission scenario. That is, a channel from the transmit end to the receive end is similar to a channel from the receive end to the transmit end, for example, this manner may be used in a time division duplexing (TDD) scenario.

In some embodiments, when the communications device is a terminal, the obtaining channel measurement information of an antenna port group includes:
sending measurement request signaling to a network side device by using the antenna port group;
receiving a downlink reference signal sent by the network side device based on the measurement request signaling; and
measuring the downlink reference signal to obtain the channel measurement information, where
the measurement request signaling includes the number of antenna port groups.

In some embodiments, when the communications device is a terminal and the communications peer end is a network side device, this transmission is uplink transmission. It can be understood that downlink measurement may be performed in an uplink transmission scenario in a unit of an antenna port group based on channel reciprocity.

In some embodiments, the measurement trigger signaling is sent by using the antenna port group. After receiving the measurement trigger signaling, the network side may send the downlink reference information in a unit of antenna port group. The terminal may measure the downlink reference information to obtain the downlink channel measurement information, which is used as a reference of uplink channel measurement information.

It can be understood that, in this embodiment of this application, in an uplink transmission scenario, uplink measurement may be further performed in a unit of antenna port group, and a base station measures an uplink channel and notifies the terminal of the uplink channel measurement information.

It can be understood that the measurement trigger signaling may include the number of antenna port groups, so that the receive end can determine channel measurement information of how many groups of channels need to be measured.

In some embodiments, when the communications device is a terminal and a communications peer end is a terminal, the obtaining channel measurement information of an antenna port group includes:
sending a sidelink reference signal and measurement trigger signaling by using the plurality of antennas; and
receiving channel measurement information fed back by the communications peer end based on the measurement trigger signaling, where
the channel measurement information is obtained by the communications peer end by means of measurement according to the sidelink reference signal, and the measurement trigger signaling includes the number of antenna port groups.

In some embodiments, when the communications device is a terminal, and the communications peer end may also be a terminal, this transmission is sidelink transmission, and channel measurement may also be performed in a unit of antenna port group.

In some embodiments, the sidelink reference signal and the measurement trigger signaling may be sent to the terminal of the communications peer end. After receiving the sidelink reference signal, the communications peer end may measure the sidelink reference signal in a unit of antenna port group to obtain the channel measurement information, and notify the terminal at the transmit end, so that the terminal at the transmit end can receive the channel measurement information fed back by the communications peer end.

It can be understood that the measurement trigger signaling may include the number of antenna port groups, so that the receive end can determine channel measurement information of how many groups of channels need to be measured.

In some embodiments, the performing information transmission according to the PMI used in the beamforming MIMO mode and the number of overlapping layers includes:
for one antenna port group, obtaining FTN information based on the number of overlapping layers;
for FTN information of at least two antenna port groups, performing digital beamforming on information of inter-antenna port groups based on a target precoding matrix, to obtain MIMO-FTN information, where the target precoding matrix is determined based on a precoding matrix indicator PMI of the antenna port group; and
transmitting the MIMO-FTN information.

In some embodiments, after at least one antenna port group is obtained by grouping the antennas, for information about an antenna in each antenna port group, FTN information may be obtained by means of superposition based on the number of overlapping layers.

In some embodiments, an antenna port group may be considered as a whole, and is a virtual antenna port. FTN information of each antenna port group may be considered as transmission information of the virtual antenna port. Then, when inter-group MIMO is performed, digital beamforming may be performed on the information of the inter-antenna port groups based on the target precoding matrix to obtain the MIMO-FTN information.

After the MIMO-FTN information is obtained, information transmission may be performed on the MIMO-FTN information.

In some embodiments, the antenna port group is obtained by grouping antennas.

The grouping antennas includes: determining the number of groups based on the number of overlapping layers; and grouping the antennas based on a grouping rule and the number of groups.

In some embodiments, when the antennas are grouped, the number of overlapping layers may be first determined based on the channel state information; the number of groups is determined based on the number of overlapping layers; and then the antennas are grouped based on the number of groups and the grouping rule to obtain the at least two antenna port groups.

In some embodiments, when the number of groups is determined based on the number of overlapping layers, the antennas may be grouped according to the number of antennas after the number of overlapping layers is determined. The number Sⱼ of antennas in each group is determined according to the number K of overlapping layers, and the antennas are grouped into L groups, where

$$L = \frac{s}{{s}_{j}} , L ∈ {\text{N}}^{+} .$$

Antennas in a same group generate FTN signals through delayed signal transmission.

For example, when the number of antennas is much greater than the number of required overlapping layers, the transmit end may group the antennas. Assuming that the total number of antennas is S and the number of required overlapping layers is K, the number Sⱼ of antennas in each group satisfies

$${S}_{j} \geq K , j = 1 , 2 , … , N . {Σ}_{j}^{N} \left\{{S}_{j}\right\} = S .$$

In some embodiments, antenna grouping may adopt a proximity grouping principle. In a view of a receive end, transmit end antennas that are relatively close may be considered as being in a same point in space, and therefore, transmit signals of the transmit end antennas may be considered as being simply superposed on an air interface on the transmit side, so as to form FTN signals.

In some embodiments, the antenna grouping rule may be as follows: (1) Being grouped by a row, that is, Sⱼ antennas in a same row in a horizontal direction in an antenna array are classified into one group; (2) Being grouped by a column, that is, Sⱼ antennas in a same column in a vertical direction in an antenna array are classified into one group; (3) Being grouped by a block, that is, Sⱼ antennas adjacent in horizontal and vertical directions in are antenna array are classified into one group. (4) Being grouped by an antenna polarization direction When dual polarized antennas are used, a pair of polarized antennas at a same location may be used separately to send same/different information as required.

It can be understood that when antennas are grouped according to a row/column/block, antennas of a same row/column/block may be further grouped according to a polarization direction, thereby increasing a spatial degree of freedom.

It can be understood that an antenna port group may be obtained through grouping performed in a unit of antenna, that is, a plurality of antennas may be grouped to obtain an antenna port group; or an antenna port group may be obtained through grouping in a unit of antenna channel, that is, a plurality of antenna channels may be grouped to obtain an antenna port group.

It can be understood that, after at least one antenna port group is obtained by grouping the antennas, delay superposition sending is performed between antennas in each antenna port group to generate an FTN signal. In addition, antenna groups may be considered as a MIMO antenna system with reduced dimensions, and information transmission may be performed on the FTN signal by using the existing MIMO working mode.

In some embodiments, for L antenna groups, each antenna group may be considered as one virtual antenna port. L virtual antenna ports may further work cooperatively by using the MIMO working mode.

According to the hybrid scheme in this embodiment, an antenna grouping manner is determined according to the number of available antennas and the number of required FTN overlapping layers, and an appropriate beamforming manner is selected for inter-antenna groups, thereby further dynamically optimizing spectrum efficiency for the SNR.

In some embodiments, after the grouping antennas, the method further includes: indicating the grouping rule to a communications peer end by using first indication information; and the determining a MIMO target working mode when a MIMO manner is used for inter-antenna port groups includes: directly determining the MIMO target working mode based on channel measurement information, and indicating the MIMO target working mode to the communications peer end by using second indication information.

In some embodiments, the communications peer end needs to know a specific antenna grouping rule, to correctly collect information for correct decoding. Therefore, after antennas are grouped based on a preset rule, the grouping rule is indicated to the communications peer end by using the first indication information. For example, 2 bits may be used to indicate four grouping rules, that is, {00, 01, 11, 10} corresponds to {vertical, horizontal, block pattern 1, block pattern 2}.

Correspondingly, when the MIMO target working mode is determined based on the measurement information of the antenna port group, the MIMO target working mode may be directly determined based on the measurement information of the antenna port group, and the MIMO target working mode is indicated to the communications peer end by using the second indication information.

It can be understood that, in this implementation, there is no direct correspondence between the grouping rule and the MIMO target working mode, and indication to the communications peer end may be separately performed.

In some embodiments, when the communications device is a network side device, the first indication information and/or the second indication information are/is carried in DCI or dedicated-RRC, or carried in a PDCCH or a PDSCH.

In some embodiments, when the communications device is a network side device and the communications peer end is a terminal, this transmission is downlink transmission. Therefore, the first indication information may be carried in downlink control information (DCI) or dedicated-RRC, or the first indication information may be carried in a physical downlink control channel (PDCCH) or a physical downlink shared channel (PDSCH). The second indication information may be carried in DCI or dedicated RRC, or the second indication information may be carried in a PDCCH or a PDSCH.

In some embodiments, when the communications device is a terminal, the first indication information and/or the second indication information are/is carried in uplink control information UCI, or carried in a PUCCH or a PUSCH.

In some embodiments, when the communications device is a terminal and the communications peer end is a network side device, this transmission is uplink transmission. Therefore, the first indication information may be carried in uplink control information UCI (UCI), or the first indication information may be carried in a physical uplink control channel (PUCCH) or a physical uplink shared channel (PUSCH). The second indication information may be carried in uplink control information UCI, or the second indication information may be carried in a PUCCH or a PUSCH.

In some embodiments, when the communications device is a terminal and the communications peer end is a terminal, the first indication information and/or the second indication information are/is carried in sidelink control signaling or a synchronization message, or carried in a PSCCH or a PSSCH or an SBCCH.

In some embodiments, when the communications device is a terminal and the communications peer end is a terminal, this transmission is sidelink transmission. Therefore, the first indication information may be carried in sidelink control signaling or a synchronization message, or the first indication information may be carried in a physical sidelink control channel (PSCCH) or a physical sidelink shared channel (PSSCH) or a sidelink broadcast control channel (SBCCH). The second indication information may be carried in sidelink control signaling or a synchronization message, or the second indication information may be carried in a PSCCH or a PSSCH or an SBCCH.

In some embodiments, the determining the number of groups based on the number of overlapping layers includes:
determining the number of groups corresponding to the grouping rule in a predefined MIMO working mode configuration table based on the number of overlapping layers; and
after the grouping antennas, the method further includes:
determining a MIMO target working mode corresponding to the number of groups in the predefined MIMO working mode configuration table based on channel measurement information; and
indicating the MIMO target working mode, and the grouping rule and the number of groups that are corresponding to the MIMO target working mode in the MIMO working mode configuration table to a communications peer end by using third indication information.

In some embodiments, the MIMO working mode configuration table may be predefined. As shown in the following Table 1, a plurality of groups of configuration information and corresponding index values are included, and a working mode of a receive end antenna, or the combination of the MIMO target working mode, the grouping rule of the MIMO target working mode in the table, and the number of groups may be indicated by indication information including an index value. Therefore, signaling can be saved, and indication to the communications peer end can be conveniently performed, or the MIMO target working mode can be more conveniently and accurately implemented.

TABLE 1

MIMO working mode configuration table

| | |
|---|---|
| Index | Value |
| mode_FTN_1 | {Grouping rule 1, the number 1 of groups, inter-group MIMO working mode 1} |
| mode_FTN_2 | {Grouping rule 2, the number 2 of groups, inter-group MIMO working mode 2} |
| mode_FTN_3 | ... |

In some embodiments, in a case that the MIMO working mode configuration table is predefined, the MIMO target working mode corresponding to the number of groups may be determined in the predefined MIMO working mode configuration table based on the measurement information of the antenna port group. For example, the number of groups is the number 2 of groups in Table 1, and the number of groups in Table 1 corresponds to an inter-group MIMO working mode 1, an inter-group MIMO working mode 2,..., and an inter-group MIMO working mode n, an optimal inter-group MIMO working mode in the inter-group MIMO working mode 1 to the inter-group MIMO working mode n may be determined based on the measurement information of the antenna port group as the MIMO target working mode. In some embodiments, after the MIMO target working mode, and the grouping rule and the number of groups corresponding to the MIMO target working mode in the table are determined, the MIMO target working mode, and the grouping rule and the number of groups corresponding to the MIMO target working mode in the table may be indicated to the communications peer end by using the third indication information.

It can be understood that the predefined MIMO working mode configuration table may be broadcast to all terminals after being predefined on the network side, or may be specified in the protocol.

It can be understood that when the network side predefines the MIMO working mode configuration table and broadcasts the predefined MIMO working mode configuration table to all the terminals, the MIMO working mode configuration table is carried by an MTB or an STB, and carried by a PBCH or a PDSCH.

In some embodiments, the third indication information includes:
the MIMO target working mode, and the grouping rule and the number of groups that are corresponding to the MIMO target working mode in the MIMO working mode configuration table; or
index information, where the index information is used to indicate the MIMO target working mode in the MIMO working mode configuration table, and the grouping rule and the number of groups that are corresponding to the MIMO target working mode in the MIMO working mode configuration table.

In some embodiments, after it is determined, based on the measurement information of the antenna port group, that one of inter-group MIMO working modes in Table 1 is the MIMO target working mode, the combination of the MIMO target working mode, the corresponding grouping rule, and the corresponding number of groups may be directly sent to the communications peer end by using the third indication information.

In some embodiments, after it is determined, based on the measurement information of the antenna port group, that one of inter-group MIMO working modes in Table 1 is the MIMO target working mode, index information corresponding to the combination of the MIMO target working mode, the corresponding grouping rule, and the corresponding number of groups may be sent to the communications peer end.

In some embodiments, when the communications device is a network side device, the third indication information is carried in DCI or dedicated-RRC, or the third indication information is carried in a PDCCH or a PDSCH.

In some embodiments, when the communications device is a network side device and a communications peer end is a terminal, this transmission is downlink transmission. Therefore, the third indication information may be carried in DCI or dedicated-RRC, or the third indication information may be carried in a PDCCH or a PDSCH.

In some embodiments, when the communications device is a terminal, the third indication information is carried in uplink control information UCI, or the third indication information is carried in a PUCCH or a PUSCH.

In some embodiments, when the communications device is a terminal and the communications peer end is a network side device, this transmission is uplink transmission. Therefore, the third indication information may be carried in uplink control information UCI, or the third indication information may be carried in a PUCCH or a PUSCH.

In some embodiments, when the communications device is a terminal and the communications peer end is a terminal, the third indication information is carried in sidelink control signaling or a synchronization message, or the third indication information is carried in a PSCCH or a PSSCH or an SBCCH.

In some embodiments, when the communications device is a terminal and the communications peer end is a terminal, this transmission is sidelink transmission. Therefore, the third indication information may be carried in sidelink control signaling or a synchronization message, or the third indication information is carried in a PSCCH or a PSSCH or an SBCCH.

In some embodiments, when the antenna working mode is the FTN mode, the method further includes:
determining the number of overlapping layers based on the channel quality, where the performing information transmission by using the antenna working mode includes: superposing antenna information based on the number of overlapping layers to obtain FTN information; and
transmitting the FTN information.

In some embodiments, in the FTN mode, the number of overlapping layers may be first determined based on the channel quality, the antenna information is superposed based on the number of overlapping layers to obtain the FTN information, and finally the FTN information is transmitted.

It can be understood that, when the number of overlapping layers is determined based on the channel quality, determining methods may include but are not limited to the following:

i. Being determined according to the SINR and the received reference signal power RSRP. The protocol may specify a table in which a group of SINRs correspond to the numbers of overlapping layers, and the table is determined by measuring the SINR table. The correspondence in the table may be obtained from experience of a simulation test.

ii. Being determined according to the SINR, the RSRP, the multipath number, and the relative speed.

iii. Being determined the SINR, the RSRP, the Doppler frequency shift or the residual frequency offset, and the multipath number.

iv. Being determined according to the bit error rate, the RSRP, the multipath number, and the relative speed.

v. Being determined according to the bit error rate, the RSRP, the Doppler frequency shift or the residual frequency offset, and the relative speed.

In some embodiments, the method further includes: re-determining the number of overlapping layers if it is determined that a transmission condition is not met, where the transmission condition includes: a bit error rate fed back by a communications peer end is not less than a first preset threshold; or the number of received packet loss retransmission NACK messages that are sent by a communications peer end reaches a second preset threshold; or the number of continuously received NACK messages that are sent by a communications peer end reaches a third preset threshold; or an SNR or RSRP of a received signal is less than a fourth preset threshold.

In some embodiments, in a case that the antenna working mode is the FTN mode or the antenna working mode is the MIMO-FTN mode, the number of overlapping layers may be re-determined when the transmission condition is not met, and MIMO gains and FTN gains in different scenarios are weighed to maximize a global throughput, to obtain an optimal transmission scheme based on the MIMO-FTN mode and to maximize transmission quality.

In some embodiments, in a case that the antenna working mode is the MIMO-FTN mode, after the number of overlapping layers is re-determined when the transmission condition is not met, grouping may be performed again based on the number of overlapping layers, and measurement and feedback may be performed again to obtain a new precoding matrix.

In some embodiments, in this embodiment of this application, when it is determined whether information transmission meets the condition, transmission of one or more data blocks may be used as a unit for determining.

In some embodiments, the transmission condition may be:

1. The bit error rate fed back by the communications peer end is not less than the first preset threshold. If the bit error rate is less than the threshold, it is considered that the transmission condition is not met.

2. The number of NACK messages received by the transmit end reaches the second preset threshold or NACK message are continuously received. For example, if M NACK messages are received cumulatively in a specific period; or N NACK messages are continuously received, it is considered that the transmission indicator is not met.

3. If the SNR or the RSRP of the received signal is less than the fourth preset threshold, it is considered that the transmission condition is not met.

It can be understood that the first preset threshold, the second preset threshold, the third preset threshold, and the fourth preset threshold may be configured by the network, or may be stipulated in the protocol.

In some embodiments, the method further includes: when the antenna working mode is the FTN mode, adjusting a sending parameter of the FTN information based on antenna measurement information, where the antenna measurement information is obtained by measuring an antenna port; and

when the antenna working mode is the MIMO-FTN mode, adjusting a sending parameter of MIMO-FTN information based on channel measurement information.

In some embodiments, first, sending parameters of information in an antenna port group, such as a QAM modulation order and a channel coding code rate, may be adjusted according to a measurement result, to ensure information transmission quality.

In some embodiments, in a case that the antenna working mode is the FTN mode, the antenna measurement information may be obtained by measuring the antenna port by the terminal, and the sending parameter of the FTN information is adjusted based on the antenna measurement information, or the adjusted sending parameter of the FTN information may be indicated to the communications peer end by using the second indication information, where the second indication information is carried in DCI or dedicated-RRC, or carried in a PDCCH or a PDSCH.

In some embodiments, in a case that the antenna working mode is the MIMO-FTN mode, the sending parameter of the FTN information may be adjusted based on the antenna port measurement information.

In some embodiments, the method further includes:
after re-determining the number of overlapping layers, indicating the re-determined number of overlapping layers to the communications peer end by using fourth indication information; or
after adjusting the sending parameter, indicating an adjusted sending parameter to the communications peer end by using fifth indication information.

In some embodiments, after the number of overlapping layers is re-determined or the sending parameter is adjusted, the communications peer end may be indicated, so that the communications peer end performs adaptive adjustment.

In some embodiments, when the communications device is a network side device, the fourth indication information and/or the fifth indication information are/is carried in DCI or dedicated-RRC, or carried in a PDCCH or a PDSCH.

In some embodiments, when the communications device is a network side device and the communications peer end is a terminal, this transmission is downlink transmission. Therefore, the fourth indication information may be carried in DCI or dedicated-RRC, or the fourth indication information may be carried in a PDCCH or a PDSCH. The fifth indication information may be carried in DCI or dedicated RRC, or the fifth indication information may be carried in a PDCCH or a PDSCH.

In some embodiments, when the communications device is a terminal, the fourth indication information and/or the fifth indication information are/is carried in uplink control information UCI, or carried in a PUCCH or a PUSCH.

In some embodiments, when the communications device is a terminal, and the communications peer end is a network side device, this transmission is uplink transmission. Therefore, the fourth indication information may be carried in uplink control information UCI, or the fourth indication information may be carried in a PSCCH or a PSSCH. The fifth indication information may be carried in uplink control information UCI, or the fifth indication information may be carried in a PSCCH or a PSSCH.

In some embodiments, when the communications device is a terminal and the communications peer end is a terminal, the fourth indication information and/or the fifth indication information are/is carried in sidelink control signaling or a synchronization message, or carried in a PUCCH or a PUSCH or an SBCCH.

In some embodiments, when the communications device is a terminal and the communications peer end is a terminal, this transmission is sidelink transmission. Therefore, the fourth indication information and/or the fifth indication information are/is carried in sidelink control signaling or a synchronization message, or carried in a PSCCH or a PSSCH or an SBCCH.

In some embodiments, when the communications device is a network side device, the method further includes:

receiving terminal capability information sent by a terminal, where the terminal capability information includes information indicating whether the terminal supports an FTN decoding algorithm, and the FTN decoding algorithm includes an uplink FTN decoding algorithm and/or a downlink FTN decoding algorithm.

In some embodiments, when performing mode adaptive switching, the multi-antenna system may determine, according to a receiver capability and a channel condition, whether to use the FTN transmission mode, and then may determine, according to a measurement result, the number of overlapping layers that can be supported by a current transceiver. Trigger and adaptive processes are as follows:

First, the transmit end may determine whether the current transmission supports FTN. This is mainly based on the following two points:
a. Capability of user equipment, that is, whether a receiver of the user equipment supports the FTN decoding algorithm (the UE reports, to the network side, whether the UE supports uplink FTN and downlink FTN); and
b. Current channel state information, for example, an SINR of a received signal.

In some embodiments, in a case that the SINR is less than the first preset threshold, it may be determined that the antenna working mode is the MIMO mode.

In a case that the SINR is greater than the second preset threshold and it is determined, based on the capability information sent by the communications peer end, that the communications peer end supports the FTN decoding algorithm, it may be determined that the antenna working mode is the FTN mode.

In a case that the SINR is greater than the first preset threshold and less than the second preset threshold and it is determined, based on the capability information sent by the communications peer end, that the communications peer end supports the FTN decoding algorithm, it may be determined that the antenna working mode is the MIMO-FTN mode.

In some embodiments, the foregoing two types of information, that is, user capability and channel state information, may be obtained by means of user feedback.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

It should be noted that the information transmission method provided in this embodiment of this application may be performed by an information transmission apparatus, or a control module that is in the information transmission apparatus and that is configured to perform the information transmission method. In this embodiment of this application, that the information transmission apparatus performs the information transmission method is used as an example to describe the information transmission apparatus provided in this embodiment of this application.

FIG. 9 is a schematic structural diagram of an information transmission apparatus according to an embodiment of this application. The apparatus is applied to a communications device. As shown in FIG. 9, the apparatus includes: a first obtaining module 910, a first determining module 920, and a first transmission module 930. The first obtaining module 910 is configured to obtain channel quality of a plurality of antennas; the first determining module 920 is configured to determine an antenna working mode according to the channel quality; and the first transmission module 930 is configured to perform information transmission by using the antenna working mode, where the antenna working mode includes a MIMO mode in which the plurality of antennas all work in a multiple-input multiple-output (MIMO) manner, an FTN mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, where each antenna port group includes at least one antenna.

In some embodiments, the information transmission apparatus obtains the channel quality of the plurality of antennas by using the first obtaining module 910, then determines the antenna working mode according to the channel quality by using the first determining module 920, and finally perform information transmission by using the first transmission module 930 by using the determined antenna working mode.

It should be noted herein that the foregoing apparatus provided in this embodiment of the present application can implement all method steps implemented in the foregoing information transmission method embodiment, and can achieve a same technical effect. Herein, parts the same as those in the method embodiment and a beneficial effect are not described in detail.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

In some embodiments, the first determining module is configured to: in a case that the channel quality is less than or equal to a first threshold, determine that the antenna working mode is the MIMO mode; in a case that the channel quality is greater than or equal to a second threshold, determine that the antenna working mode is the FTN mode; and in a case that the channel quality is greater than the first threshold and less than the second threshold, determine that the antenna working mode is the MIMO-FTN mode.

In some embodiments, the apparatus further includes: a switching module, configured to switch the antenna working mode according to updated channel quality; and a second transmission module, configured to perform information transmission by using a switched antenna working mode.

In some embodiments, the channel quality is determined according to a first channel quality parameter, and the first channel quality parameter includes at least one of a signal-to-noise ratio SNR, a signal to interference plus noise ratio SINR, reference signal received power RSRP, or reference signal received quality RSRQ.

In some embodiments, when the communications device is a terminal, the first obtaining module is configured to: receive a downlink reference signal by using the plurality of antennas; and measure the downlink reference signal to obtain the channel quality.

In some embodiments, when the communications device is a terminal and a communications peer end is a terminal, the first obtaining module is configured to:

send a sidelink reference signal by using the plurality of antennas; and receive channel quality fed back by the communications peer end, where the channel quality is obtained by the communications peer end by means of measurement according to the sidelink reference signal.

In some embodiments, when the communications device is a network side device, the first obtaining module is configured to: send a downlink reference signal by using the plurality of antennas; and receive channel state information CSI fed back by the terminal, to obtain the channel quality, where the CSI is obtained by the terminal by means of measurement according to the downlink reference signal.

In some embodiments, when the communications device is a network side device, the first obtaining module is configured to: receive an uplink reference signal by using the plurality of antennas; and measure the uplink reference signal to obtain the channel quality.

In some embodiments, when the antenna working mode is the MIMO-FTN mode, the apparatus further includes: a second determining module, configured to determine the number of overlapping layers when an FTN manner is used for an intra-antenna port group; and a third determining module, configured to determine a MIMO target working mode when a MIMO manner is used for inter-antenna port groups, where the first transmission module is configured to: perform information transmission according to the MIMO target working mode and the number of overlapping layers.

In some embodiments, the second determining module is configured to determine the number of overlapping layers based on the channel quality.

In some embodiments, the channel quality is determined according to a second channel quality parameter, and the second channel quality parameter includes at least one of the following: an SINR, RSRP, the multipath number, a relative speed, a Doppler frequency shift, a residual frequency offset after frequency offset correction, or a bit error rate.

In some embodiments, in a case that the MIMO target working mode is a beamforming MIMO mode, the apparatus further includes: a fourth determining module, configured to determine a precoding matrix indicator PMI of an antenna port group according to channel measurement information of the antenna port group; and the first transmission module is configured to perform information transmission according to the PMI used in the beamforming MIMO mode and the number of overlapping layers.

In some embodiments, the fourth determining module is configured to: obtain channel measurement information of an antenna port group; and determine a precoding matrix indicator PMI of the antenna port group according to the channel measurement information of the antenna port group.

In some embodiments, when the communications device is a network side device, the fourth determining module is further configured to: send a downlink reference signal and measurement trigger signaling to a terminal by using the antenna port group; receive channel state information CSI fed back by the terminal based on the measurement trigger signaling; and determine the precoding matrix indicator PMI of the antenna port group according to CSI of the antenna port group, where the CSI is obtained by the terminal by means of measurement according to the downlink reference signal, and the measurement trigger signaling includes the number of antenna port groups.

In some embodiments, when the communications device is a network side device, the fourth determining module is configured to: send measurement trigger signaling to a terminal by using the antenna port group; receive an uplink reference signal sent by the terminal based on the measurement trigger signaling; and measure the uplink reference signal to obtain the channel measurement information, where the measurement trigger signaling includes the number of antenna port groups.

In some embodiments, when the communications device is a terminal, the fourth determining module is configured to: send measurement request signaling to a network side device by using the antenna port group; receive a downlink reference signal sent by the network side device based on the measurement request signaling; and measure the downlink reference signal to obtain the channel measurement information, where the measurement request signaling includes the number of antenna port groups.

In some embodiments, when the communications device is a terminal and a communications peer end is a terminal, the fourth determining module is configured to: send a sidelink reference signal and measurement trigger signaling by using the plurality of antennas; receive channel measurement information fed back by the communications peer end based on the measurement trigger signaling, where the channel measurement information is obtained by the communications peer end by means of measurement according to the sidelink reference signal, and the measurement trigger signaling includes the number of antenna port groups.

In some embodiments, the first transmission module is further configured to: for one antenna port group, obtain FTN information based on the number of overlapping layers; for FTN information of at least two antenna port groups, perform digital beamforming on information of inter-antenna port groups based on a target precoding matrix, to obtain MIMO-FTN information, where the target precoding matrix is determined based on a precoding matrix indicator PMI of the antenna port group; and transmit the MIMO-FTN information.

In some embodiments, the antenna port group is obtained by grouping antennas, where the grouping antennas includes:

determining the number of groups based on the number of overlapping layers; and grouping the antennas based on a grouping rule and the number of groups.

In some embodiments, after the antennas are grouped, the apparatus further includes: a first indication module, configured to indicate the grouping rule to a communications peer end by using first indication information; and the third determining module is further configured to: directly determine the MIMO target working mode based on channel measurement information, and indicate the MIMO target working mode to the communications peer end by using second indication information.

In some embodiments, when the communications device is a network side device, the first indication information and/or the second indication information are/is carried in DCI or dedicated-RRC, or carried in a PDCCH or a PDSCH.

In some embodiments, when the communications device is a terminal, the first indication information and/or the second indication information are/is carried in uplink control information UCI, or carried in a PUCCH or a PUSCH.

In some embodiments, when the communications device is a terminal and the communications peer end is a terminal, the first indication information and/or the second indication information are/is carried in sidelink control signaling or a synchronization message, or carried in a PSCCH or a PSSCH or an SBCCH.

In some embodiments, the number of groups based on the number of overlapping layers includes: determining the number of groups corresponding to the grouping rule in a predefined MIMO working mode configuration table based on the number of overlapping layers; and after the antennas are grouped, the apparatus further includes: a fourth determining module, configured to determine a MIMO target working mode corresponding to the number of groups in the predefined MIMO working mode configuration table based on channel measurement information; and a second indication module, configured to indicate the MIMO target working mode, and the grouping rule and the number of groups that are corresponding to the MIMO target working mode in the MIMO working mode configuration table to a communications peer end by using third indication information.

In some embodiments, the third indication information includes: the MIMO target working mode, and the grouping rule and the number of groups that are corresponding to the MIMO target working mode in the MIMO working mode configuration table; or index information, where the index information is used to indicate the MIMO target working mode in the MIMO working mode configuration table, and the grouping rule and the number of groups that are corresponding to the MIMO target working mode in the MIMO working mode configuration table.

In some embodiments, when the communications device is a network side device, the third indication information is carried in DCI or dedicated-RRC, or the third indication information is carried in a PDCCH or a PDSCH.

In some embodiments, when the communications device is a terminal, the third indication information is carried in uplink control information UCI, or the third indication information is carried in a PUCCH or a PUSCH.

In some embodiments, when the communications device is a terminal and the communications peer end is a terminal, the third indication information is carried in sidelink control signaling or a synchronization message, or the third indication information is carried in a PSCCH or a PSSCH or an SBCCH.

In some embodiments, when the antenna working mode is the FTN mode, the apparatus further includes: a fifth determining module, configured to determine the number of overlapping layers based on the channel quality; and the first transmission module is configured to: superpose antenna information based on the number of overlapping layers to obtain FTN information; and transmit the FTN information.

In some embodiments, the apparatus further includes a sixth determining module, configured to: if it is determined that a transmission condition is not met, re-determine the number of overlapping layers, where the transmission condition includes:
a bit error rate fed back by a communications peer end is not less than a first preset threshold; or
the number of received NACK messages that are sent by a communications peer end reaches a second preset threshold; or
the number of continuously received NACK messages that are sent by a communications peer end reaches a third preset threshold; or
an SNR or RSRP of a received signal is less than a fourth preset threshold.

In some embodiments, the apparatus further includes a first adjustment module, configured to: when the antenna working mode is the FTN mode, adjust a sending parameter of the FTN information based on antenna measurement information, where the antenna measurement information is obtained by measuring an antenna port; and a second adjustment module, configured to: when the antenna working mode is the MIMO-FTN mode, adjust a sending parameter of MIMO-FTN information based on channel measurement information.

In some embodiments, the apparatus further includes: a third indication module, configured to: after the number of overlapping layers is re-determined, indicate the re-determined number of overlapping layers to the communications peer end by using fourth indication information; or a fourth indication module, configured to: after the sending parameter is adjusted, indicate an adjusted sending parameter to the communications peer end by using fifth indication information.

In some embodiments, when the communications device is a network side device, the fourth indication information and/or the fifth indication information are/is carried in DCI or dedicated-RRC, or carried in a PDCCH or a PDSCH.

In some embodiments, when the communications device is a terminal, the fourth indication information and/or the fifth indication information are/is carried in uplink control information UCI, or carried in a PUCCH or a PUSCH.

In some embodiments, when the communications device is a terminal and the communications peer end is a terminal, the fourth indication information and/or the fifth indication information are/is carried in sidelink control signaling or a synchronization message, or carried in a PSCCH or a PSSCH or an SBCCH.

In some embodiments, when the communications device is a network side device, the apparatus further includes:

a receiving module, configured to receive terminal capability information sent by a terminal, where the terminal capability information includes information indicating whether the terminal supports an FTN decoding algorithm, and the FTN decoding algorithm includes an uplink FTN decoding algorithm and/or a downlink FTN decoding algorithm.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

The information transmission apparatus in this embodiment of this application may be an apparatus, or may be a component, an integrated circuit, or a chip in a terminal. The apparatus may be a mobile terminal, or a non-mobile terminal. For example, the mobile device may include but is not limited to the types of the foregoing listed terminal 11, and the non-mobile terminal may be a server, a network attached storage (Network Attached Storage, NAS), a personal computer (personal computer, PC), a television (television, TV), an automated teller machine, or a self-service machine. This is not limited in the embodiments of this application.

The information transmission apparatus in this embodiment of this application may be an apparatus with an operating system. The operating system may be an Android (Android) operating system, an iOS operating system, or another possible operating system. This is not limited in the embodiments of this application.

The information transmission apparatus provided in this embodiment of this application can implement the processes implemented in the method embodiments in FIG. 2 to FIG. 8, and achieve a same technical effect. To avoid repetition, details are not described herein again.

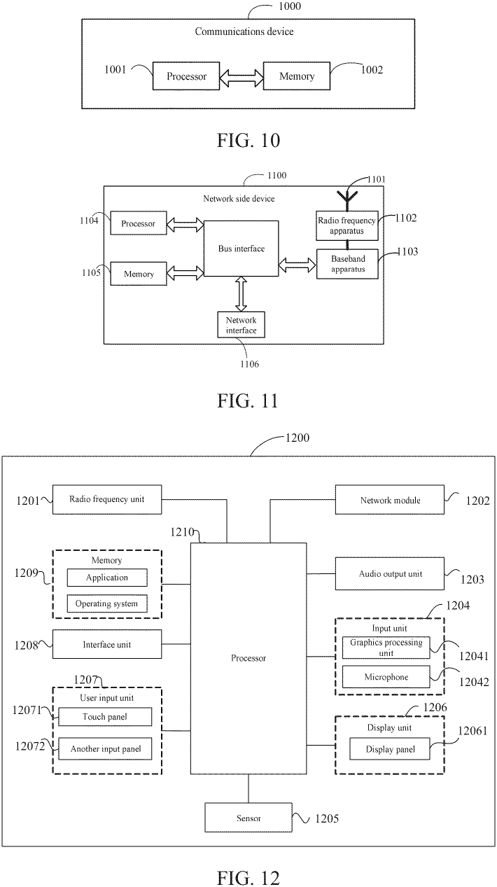

In some embodiments, FIG. 10 is a schematic structural diagram of a communications device according to an embodiment of this application. As shown in FIG. 10, the communications device 1000 includes a processor 1001, a memory 1002, a program or an instruction that is stored in the memory 1002 and may run on the processor 1001. For example, when the communications device 1000 is a terminal, the program or the instruction is executed by the processor 1001 to implement each process of the foregoing synchronization signal block transmission method embodiment, and a same technical effect can be achieved. When the communications device 1000 is a network side device, the program or the instruction is executed by the processor 1001 to implement the processes of the foregoing information transmission method embodiment, and a same technical effect can be achieved. To avoid repetition, details are not described herein again.

It can be understood that the communications device in this application may be a network side device, or may be a terminal.

FIG. 11 is a schematic structural diagram of hardware of a network side device according to an embodiment of this application.

As shown in FIG. 11, a network side device 1100 includes an antenna 1101, a radio frequency apparatus 1102, and a baseband apparatus 1103. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information by using the antenna 1101.

The frequency band processing apparatus may be located in the baseband apparatus 1103. The method performed by the network side device in the foregoing embodiment may be implemented in the baseband apparatus 1103. The baseband apparatus 1103 includes a processor 1104 and a memory 1105.

The baseband apparatus 1103 may include, for example, at least one baseband board, where a plurality of chips are disposed on the baseband board. As shown in FIG. 11, one chip is, for example, the processor 1104, which is connected to the memory 1105, so as to invoke a program in the memory 1105 to perform operations of the network device shown in the foregoing method embodiment.

The baseband apparatus 1103 may further include a network interface 1106, configured to exchange information with the radio frequency apparatus 1102. For example, the interface is a common public radio interface (CPRI).

In some embodiments, the network side device in this embodiment of this application further includes an instruction or a program that is stored in the memory 1105 and that can be run on the processor 1104. The processor 1104 invokes the instruction or the program in the memory 1105 to perform the method performed by the modules shown in FIG. 9, and a same technical effect is achieved. To avoid repetition, details are not described herein again.

The processor 1104 is configured to: obtain channel quality of a plurality of antennas; determine an antenna working mode according to the channel quality; and perform information transmission by using the antenna working mode, where the antenna working mode includes a MIMO mode in which the plurality of antennas all work in a multiple-input multiple-output (MIMO) manner, an FTN mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, where each antenna port group includes at least one antenna.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

In some embodiments, the processor 1104 is further configured to perform at least one of the following: in a case that the channel quality is less than or equal to a first threshold, determining that the antenna working mode is the MIMO mode; in a case that the channel quality is greater than or equal to a second threshold, determining that the antenna working mode is the FTN mode; or in a case that the channel quality is greater than the first threshold and less than the second threshold, determining that the antenna working mode is the MIMO-FTN mode.

In some embodiments, after determining the antenna working mode according to the channel quality, the processor 1104 is further configured to: switch the antenna working mode according to updated channel quality; and perform information transmission by using a switched antenna working mode.

In some embodiments, the channel quality is determined according to a first channel quality parameter, and the first channel quality parameter includes at least one of a signal-to-noise ratio SNR, a signal to interference plus noise ratio SINR, reference signal received power RSRP, or reference signal received quality RSRQ.

In some embodiments, when the communications device is a network side device, the processor 1104 is further configured to: send a downlink reference signal by using the plurality of antennas; and receive channel state information CSI fed back by the terminal, to obtain the channel quality, where the CSI is obtained by the terminal by means of measurement according to the downlink reference signal.

In some embodiments, when the communications device is a network side device, the processor 1104 is further configured to: receive an uplink reference signal by using the plurality of antennas; and measure the uplink reference signal to obtain the channel quality.

In some embodiments, when the antenna working mode is the MIMO-FTN mode, the processor 1104 is further configured to: determine the number of overlapping layers when an FTN manner is used for an intra-antenna port group; and determine a MIMO target working mode when a MIMO manner is used for inter-antenna port groups, where the performing information transmission by using the antenna working mode includes: performing information transmission according to the MIMO target working mode and the number of overlapping layers.

In some embodiments, the processor 1104 is further configured to determine the number of overlapping layers based on the channel quality.

In some embodiments, the channel quality is determined according to a second channel quality parameter, and the second channel quality parameter includes at least one of the following: an SINR, RSRP, the multipath number, a relative speed, a Doppler frequency shift, a residual frequency offset after frequency offset correction, or a bit error rate.

In some embodiments, in a case that the MIMO target working mode is a beamforming MIMO mode, the processor 1104 is further configured to: determine a precoding matrix indicator PMI of the antenna port group according to the channel measurement information of the antenna port group, where
the performing information transmission according to the MIMO target working mode and the number of overlapping layers includes:
performing information transmission according to the PMI used in the beamforming MIMO mode and the number of overlapping layers.

In some embodiments, the processor 1104 is further configured to: obtain channel measurement information of an antenna port group; and determine a precoding matrix indicator PMI of the antenna port group according to the channel measurement information of the antenna port group.

In some embodiments, when the communications device is a network side device, the processor 1104 is further configured to: send a downlink reference signal and measurement trigger signaling to a terminal by using the antenna port group; receive channel state information CSI fed back by the terminal based on the measurement trigger signaling; and determine the precoding matrix indicator PMI of the antenna port group according to CSI of the antenna port group, where the CSI is obtained by the terminal by means of measurement according to the downlink reference signal, and the measurement trigger signaling includes the number of antenna port groups.

In some embodiments, when the communications device is a network side device, the processor 1104 is further configured to: send measurement trigger signaling to a terminal by using the antenna port group; receive an uplink reference signal sent by the terminal based on the measurement trigger signaling; and

measure the uplink reference signal to obtain the channel measurement information, where the measurement trigger signaling includes the number of antenna port groups.

In some embodiments, the processor 1104 is further configured to: for one antenna port group, obtain FTN information based on the number of overlapping layers; for FTN information of at least two antenna port groups, perform digital beamforming on information of inter-antenna port groups based on a target precoding matrix, to obtain MIMO-FTN information, where the target precoding matrix is determined based on a precoding matrix indicator PMI of the antenna port group; and transmit the MIMO-FTN information.

In some embodiments, the antenna port group is obtained by grouping antennas. The processor 1104 is further configured to:

determine the number of groups based on the number of overlapping layers; and group the antennas based on a grouping rule and the number of groups.

In some embodiments, after the antennas are grouped, the processor 1104 is further configured to indicate the grouping rule to a communications peer end by using first indication information.

The determining a MIMO target working mode when a MIMO manner is used for inter-antenna port groups includes: directly determining the MIMO target working mode based on channel measurement information, and indicating the MIMO target working mode to the communications peer end by using second indication information.

In some embodiments, when the communications device is a network side device, the first indication information and/or the second indication information are/is carried in DCI or dedicated-RRC, or carried in a PDCCH or a PDSCH.

In some embodiments, when the communications device is a terminal, the first indication information and/or the second indication information are/is carried in uplink control information UCI, or carried in a PUCCH or a PUSCH.

In some embodiments, when the communications device is a terminal and the communications peer end is a terminal, the first indication information and/or the second indication information are/is carried in sidelink control signaling or a synchronization message, or carried in a PSCCH or a PSSCH or an SBCCH.

In some embodiments, the processor 1104 is further configured to determine the number of groups corresponding to the grouping rule in a predefined MIMO working mode configuration table based on the number of overlapping layers; and
after the grouping antennas, the method further includes:
determining a MIMO target working mode corresponding to the number of groups in the predefined MIMO working mode configuration table based on channel measurement information; and
indicating the MIMO target working mode, and the grouping rule and the number of groups that are corresponding to the MIMO target working mode in the MIMO working mode configuration table to a communications peer end by using third indication information.

In some embodiments, the third indication information includes: the MIMO target working mode, and the grouping rule and the number of groups that are corresponding to the MIMO target working mode in the MIMO working mode configuration table; or index information, where the index information is used to indicate the MIMO target working mode in the MIMO working mode configuration table, and the grouping rule and the number of groups that are corresponding to the MIMO target working mode in the MIMO working mode configuration table.

In some embodiments, when the communications device is a network side device, the third indication information is carried in DCI or dedicated-RRC, or the third indication information is carried in a PDCCH or a PDSCH.

In some embodiments, when the antenna working mode is the FTN mode, the processor 1104 is further configured to determine the number of overlapping layers based on the channel quality, where the performing information transmission by using the antenna working mode includes: superposing antenna information based on the number of overlapping layers to obtain FTN information; and transmitting the FTN information.

In some embodiments, the processor 1104 is further configured to re-determine the number of overlapping layers if it is determined that a transmission condition is not met, where
the transmission condition includes: a bit error rate fed back by a communications peer end is not less than a first preset threshold; or
the number of received NACK messages that are sent by a communications peer end reaches a second preset threshold; or
the number of continuously received NACK messages that are sent by a communications peer end reaches a third preset threshold; or
an SNR or RSRP of a received signal is less than a fourth preset threshold.

In some embodiments, the processor 1104 is further configured to: when the antenna working mode is the FTN mode, adjust a sending parameter of the FTN information based on antenna measurement information, where the antenna measurement information is obtained by measuring an antenna port; and

when the antenna working mode is the MIMO-FTN mode, adjust a sending parameter of MIMO-FTN information based on channel measurement information.

In some embodiments, the processor 1104 is further configured to: after re-determining the number of overlapping layers, indicate the re-determined number of overlapping layers to the communications peer end by using fourth indication information; or after adjusting the sending parameter, indicate an adjusted sending parameter to the communications peer end by using fifth indication information.

In some embodiments, when the communications device is a network side device, the fourth indication information and/or the fifth indication information are/is carried in DCI or dedicated-RRC, or carried in a PDCCH or a PDSCH.

In some embodiments, when the communications device is a network side device, the processor 1104 is further configured to:

receive terminal capability information sent by a terminal, where the terminal capability information includes information indicating whether the terminal supports an FTN decoding algorithm, and the FTN decoding algorithm includes an uplink FTN decoding algorithm and/or a downlink FTN decoding algorithm.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

FIG. 12 is a schematic structural diagram of hardware of a terminal according to an embodiment of this application.

A terminal 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that, in this embodiment of this application, the input unit 1204 may include a graphics processing unit (GPU) 12041 and a microphone 12042, and the graphics processing unit 12041 processes image data of a still picture or a video obtained by an image capture apparatus (such as a camera) in a video capture mode or an image capture mode. The display unit 1206 may include a display panel 12061. In some embodiments, the display panel 12061 may be configured in a form such as a liquid crystal display or an organic light-emitting diode. The user input unit 1207 includes a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving information from a communications peer end, the radio frequency unit 1201 sends the information to the processor 1210 for processing, and sends to-be-transmitted information to the communications peer end. Usually, the radio frequency unit 1201 includes but is not limited to an antenna, at least one amplifier, a transceiver, a coupler, a low noise amplifier, a duplexer, and the like.

The memory 1209 may be configured to store a software program or an instruction and various data. The memory 1209 may mainly include a program or instruction storage area and a data storage area. The program or instruction storage area may store an operating system, and an application or an instruction required by at least one function (for example, a sound playing function or an image playing function). In addition, the memory 1209 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage component, a flash memory component, or another non-volatile solid-state storage component.

The processor 1210 may include one or more processing units. In some embodiments, an application processor and a modem processor may be integrated into the processor 1210. The application processor mainly processes an operating system, a user interface, an application, an instruction, or the like. The modem processor mainly processes wireless communications, for example, a baseband processor. It can be understood that, alternatively, the modem processor may not be integrated into the processor 1210.

The processor 1210 is configured to: obtain channel quality of a plurality of antennas; determine an antenna working mode according to the channel quality; and perform information transmission by using the antenna working mode, where the antenna working mode includes a MIMO mode in which the plurality of antennas all work in a multiple-input multiple-output (MIMO) manner, an FTN mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, where each antenna port group includes at least one antenna.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

In some embodiments, the processor 1210 is further configured to perform at least one of the following:
in a case that the channel quality is less than or equal to a first threshold, determining that the antenna working mode is the MIMO mode;
in a case that the channel quality is greater than or equal to a second threshold, determining that the antenna working mode is the FTN mode; or
in a case that the channel quality is greater than the first threshold and less than the second threshold, determining that the antenna working mode is the MIMO-FTN mode.

In some embodiments, after determining the antenna working mode according to the channel quality, the processor 1210 is further configured to: switch the antenna working mode according to updated channel quality; and perform information transmission by using a switched antenna working mode.

In some embodiments, the channel quality is determined according to a first channel quality parameter, and the first channel quality parameter includes at least one of a signal-to-noise ratio SNR, a signal to interference plus noise ratio SINR, reference signal received power RSRP, or reference signal received quality RSRQ.

In some embodiments, when the communications device is a terminal, the processor 1210 is further configured to: receive a downlink reference signal by using the plurality of antennas; and measure the downlink reference signal to obtain the channel quality.

In some embodiments, when the communications device is a terminal and a communications peer end is a terminal, the processor 1210 is further configured to: send a sidelink reference signal by using the plurality of antennas; and receive channel quality fed back by the communications peer end, where the channel quality is obtained by the communications peer end by means of measurement according to the sidelink reference signal.

In some embodiments, when the antenna working mode is the MIMO-FTN mode, the processor 1210 is further configured to: determine the number of overlapping layers when an FTN manner is used for an intra-antenna port group; and determine a MIMO target working mode when a MIMO manner is used for inter-antenna port groups, where the performing information transmission by using the antenna working mode includes:

performing information transmission according to the MIMO target working mode and the number of overlapping layers.

In some embodiments, the processor 1210 is further configured to determine the number of overlapping layers based on the channel quality.

In some embodiments, the channel quality is determined according to a second channel quality parameter, and the second channel quality parameter includes at least one of the following: an SINR, RSRP, the multipath number, a relative speed, a Doppler frequency shift, a residual frequency offset after frequency offset correction, or a bit error rate.

In some embodiments, in a case that the MIMO target working mode is a beamforming MIMO mode, the processor 1210 is further configured to: determine a precoding matrix indicator PMI of the antenna port group according to the channel measurement information of the antenna port group, where
the performing information transmission according to the MIMO target working mode and the number of overlapping layers includes:
performing information transmission according to the PMI used in the beamforming MIMO mode and the number of overlapping layers.

In some embodiments, the processor 1210 is further configured to: obtain channel measurement information of an antenna port group; and determine a precoding matrix indicator PMI of the antenna port group according to the channel measurement information of the antenna port group.

In some embodiments, when the communications device is a terminal, the processor 1210 is further configured to:
send measurement request signaling to a network side device by using the antenna port group;
receive a downlink reference signal sent by the network side device based on the measurement request signaling; and
measure the downlink reference signal to obtain the channel measurement information, where
the measurement request signaling includes the number of antenna port groups.

In some embodiments, when the communications device is a terminal and a communications peer end is a terminal, the processor 1210 is further configured to:
send a sidelink reference signal and measurement trigger signaling by using the plurality of antennas; and
receive channel measurement information fed back by the communications peer end based on the measurement trigger signaling, where
the channel measurement information is obtained by the communications peer end by means of measurement according to the sidelink reference signal, and the measurement trigger signaling includes the number of antenna port groups.

In some embodiments, the processor 1210 is further configured to:
for one antenna port group, obtain FTN information based on the number of overlapping layers;
for FTN information of at least two antenna port groups, perform digital beamforming on information of inter-antenna port groups based on a target precoding matrix, to obtain MIMO-FTN information, where
the target precoding matrix is determined based on a precoding matrix indicator PMI of the antenna port group; and
transmit the MIMO-FTN information.

In some embodiments, the antenna port group is obtained by grouping antennas.

The processor 1210 is further configured to: determine the number of groups based on the number of overlapping layers; and

group the antennas based on a grouping rule and the number of groups.

In some embodiments, after the antennas are grouped, the processor 1210 is further configured to indicate the grouping rule to a communications peer end by using first indication information.

The determining a MIMO target working mode when a MIMO manner is used for inter-antenna port groups includes: directly determining the MIMO target working mode based on channel measurement information, and indicating the MIMO target working mode to the communications peer end by using second indication information.

In some embodiments, when the communications device is a terminal, the first indication information and/or the second indication information are/is carried in uplink control information UCI, or carried in a PUCCH or a PUSCH.

In some embodiments, when the communications device is a terminal and the communications peer end is a terminal, the first indication information and/or the second indication information are/is carried in sidelink control signaling or a synchronization message, or carried in a PSCCH or a PSSCH or an SBCCH.

In some embodiments, the processor 1210 is further configured to determine the number of groups corresponding to the grouping rule in a predefined MIMO working mode configuration table based on the number of overlapping layers; and
after the grouping antennas, the method further includes:
determining a MIMO target working mode corresponding to the number of groups in the predefined MIMO working mode configuration table based on channel measurement information; and
indicating the MIMO target working mode, and the grouping rule and the number of groups that are corresponding to the MIMO target working mode in the MIMO working mode configuration table to a communications peer end by using third indication information.

In some embodiments, the third indication information includes:
the MIMO target working mode, and the grouping rule and the number of groups that are corresponding to the MIMO target working mode in the MIMO working mode configuration table; or
index information, where the index information is used to indicate the MIMO target working mode in the MIMO working mode configuration table, and the grouping rule and the number of groups that are corresponding to the MIMO target working mode in the MIMO working mode configuration table.

In some embodiments, when the communications device is a terminal, the third indication information is carried in uplink control information UCI, or the third indication information is carried in a PUCCH or a PUSCH.

In some embodiments, when the communications device is a terminal and the communications peer end is a terminal, the third indication information is carried in sidelink control signaling or a synchronization message, or the third indication information is carried in a PSCCH or a PSSCH or an SBCCH.

In some embodiments, when the antenna working mode is the FTN mode, the processor 1210 is further configured to determine the number of overlapping layers based on the channel quality, where the performing information transmission by using the antenna working mode includes: superposing antenna information based on the number of overlapping layers to obtain FTN information; and transmitting the FTN information.

In some embodiments, the processor 1210 is further configured to re-determine the number of overlapping layers if it is determined that a transmission condition is not met, where
the transmission condition includes: a bit error rate fed back by a communications peer end is not less than a first preset threshold; or the number of received NACK messages that are sent by a communications peer end reaches a second preset threshold; or
the number of continuously received NACK messages that are sent by a communications peer end reaches a third preset threshold; or
an SNR or RSRP of a received signal is less than a fourth preset threshold.

In some embodiments, the processor 1210 is further configured to:
when the antenna working mode is the FTN mode, adjust a sending parameter of the FTN information based on antenna measurement information, where the antenna measurement information is obtained by measuring an antenna port; and
when the antenna working mode is the MIMO-FTN mode, adjust a sending parameter of MIMO-FTN information based on channel measurement information.

In some embodiments, the processor 1210 is further configured to:
after re-determining the number of overlapping layers, indicate the re-determined number of overlapping layers to the communications peer end by using fourth indication information; or
after adjusting the sending parameter, indicate an adjusted sending parameter to the communications peer end by using fifth indication information.

In some embodiments, when the communications device is a terminal, the fourth indication information and/or the fifth indication information are/is carried in uplink control information UCI, or carried in a PUCCH or a PUSCH.

In some embodiments, when the communications device is a terminal and the communications peer end is a terminal, the fourth indication information and/or the fifth indication information are/is carried in sidelink control signaling or a synchronization message, or carried in a PSCCH or a PSSCH or an SBCCH.

In this embodiment of this application, an antenna working mode is determined based on channel state information, and information transmission is performed. During information transmission, an appropriate transmission mode may be adaptively selected according to a channel state to perform information transmission, and a working mode of a multi-antenna system is flexibly adjusted. Therefore, spectrum efficiency is dynamically optimized for a channel state, so that a receiver can track a time-varying characteristic of a fading channel, and always remains in an optimal working state.

An embodiment of this application further provides a readable storage medium. The readable storage medium stores a program or an instruction, and when the program or the instruction is executed by a processor, the processes of the foregoing information transmission method embodiment are implemented and a same technical effect can be achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communications interface, the communications interface is coupled to the processor, and the processor is configured to run a program or an instruction of a network side device to implement the processes of the foregoing information transmission method embodiment and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “including a ...” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the laims, all of which fall within the protection of this application.

What is claimed is:

1. An information transmission method, comprising:
obtaining, by a communications device, channel quality of a plurality of antennas;
determining, by the communications device, an antenna working mode according to the channel quality; and
performing, by the communications device, information transmission by using the antenna working mode, wherein
the antenna working mode comprises a MIMO mode in which the plurality of antennas all work in a multiple-input multiple-output (MIMO) manner, a faster-than-Nyquist (FTN) mode in which the plurality of antennas all work in a faster-than-Nyquist (FTN) manner, or a MIMO-FTN mode in which an FTN manner is used for a same intra-antenna port group in the plurality of antennas and a MIMO manner is used for different inter-antenna port groups, wherein each antenna port group comprises at least one antenna.

2. The information transmission method of claim 1, wherein the determining, by the communications device, the antenna working mode according to the channel quality comprises at least one of the following:
in a case that the channel quality is less than or equal to a first threshold, determining, by the communications device, that the antenna working mode is the MIMO mode;
in a case that the channel quality is greater than or equal to a second threshold, determining, by the communications device, that the antenna working mode is the FTN mode; or
in a case that the channel quality is greater than the first threshold and less than the second threshold, determining, by the communications device, that the antenna working mode is the MIMO-FTN mode.

3. The information transmission method of claim 1, wherein after the determining, by the communications device, the antenna working mode according to the channel quality, the method further comprises:
switching, by the communications device, the antenna working mode according to updated channel quality; and
performing, by the communications device, information transmission by using a switched antenna working mode.

4. The information transmission method of claim 2, wherein the channel quality is determined according to the first channel quality parameter, and the first channel quality parameter comprises at least one of a signal-to-noise ratio (SNR), a signal to interference plus noise ratio (SINR), reference signal received power (RSRP), or reference signal received quality (RSRQ).

5. The information transmission method of claim 1, wherein when the communications device is a terminal, the obtaining, by a communications device, channel quality of a plurality of antennas comprises:
receiving, by the communications device, a downlink reference signal by using the plurality of antennas; and
measuring, by the communications device, the downlink reference signal to obtain the channel quality; or,
wherein when the communications device is a terminal and a communications peer end is a terminal, the obtaining, by a communications device, channel quality of a plurality of antennas comprises:
sending, by the communications device, a sidelink reference signal by using the plurality of antennas; and
receiving, by the communications device, channel quality fed back by the communications peer end, wherein the channel quality is obtained by the communications peer end by means of measurement according to the sidelink reference signal; or,
wherein when the communications device is a network side device, the obtaining, by a communications device, channel quality of a plurality of antennas comprises:
sending, by the communications device, a downlink reference signal by using the plurality of antennas; and
receiving, by the communications device, channel state information (CSI) fed back by a terminal, to obtain the channel quality, wherein the CSI is obtained by the terminal by means of measurement according to the downlink reference signal; or,
wherein when the communications device is a network side device, the obtaining, by a communications device, channel quality of a plurality of antennas comprises:
receiving, by the communications device, an uplink reference signal by using the plurality of antennas; and
measuring, by the communications device, the uplink reference signal to obtain the channel quality.

6. The information transmission method of claim 1, wherein when the antenna working mode is the MIMO-FTN mode, the method further comprises:
determining, by the communications device, the number of overlapping layers when an FTN manner is used for an intra-antenna port group; and
determining, by the communications device, a MIMO target working mode when a MIMO manner is used for inter-antenna port groups; wherein
the performing, by the communications device, information transmission by using the antenna working mode comprises:
performing, by the communications device, information transmission according to the MIMO target working mode and the number of overlapping layers.

7. The information transmission method of claim 6, wherein the determining, by the communications device, the number of overlapping layers when an FTN manner is used for an intra-antenna port group comprises:
determining, by the communications device, the number of overlapping layers based on the channel quality;
wherein the channel quality is determined according to a second channel quality parameter, and the second channel quality parameter comprises at least one of the following: an SINR, RSRP, the multipath number, a relative speed, a Doppler frequency shift, a residual frequency offset after frequency offset correction, or a bit error rate.

8. The information transmission method according to claim 6, wherein in a case that the MIMO target working mode is a beamforming MIMO mode, the method further comprises:
determining, by the communications device, a precoding matrix indicator (PMI) of an antenna port group according to channel measurement information of the antenna port group; and
the performing, by the communications device, information transmission according to the MIMO target working mode and the number of overlapping layers comprises:
performing, by the communications device, information transmission according to the PMI used in the beamforming MIMO mode and the number of overlapping layers.

9. The information transmission method of claim 8, wherein the determining, by the communications device, a precoding matrix indicator (PMI) when a MIMO manner is used for inter-antenna port groups comprises:
obtaining, by the communications device, channel measurement information of an antenna port group; and
determining, by the communications device, a precoding matrix indicator PMI of the antenna port group according to the channel measurement information of the antenna port group.

10. The information transmission method of claim 8, wherein the performing, by the communications device, information transmission according to the PMI used in the beamforming MIMO mode and the number of overlapping layers comprises:
for one antenna port group, obtaining, by the communications device, FTN information based on the number of overlapping layers;
for FTN information of at least two antenna port groups, performing, by the communications device, digital beamforming on information of inter-antenna port groups based on a target precoding matrix, to obtain MIMO-FTN information, wherein
the target precoding matrix is determined based on a precoding matrix indicator (PMI) of the antenna port group; and
transmitting, by the communications device, the MIMO-FTN information.

11. The information transmission method of claim 1, wherein the antenna port group is obtained by grouping, by the communications device, antennas; and
the grouping, by the communications device, antennas comprises:
determining, by the communications device, the number of groups based on the number of overlapping layers; and
grouping, by the communications device, the antennas based on a grouping rule and the number of groups.

12. The information transmission method of claim 6, wherein after the grouping, by the communications device, antennas, the method further comprises:
indicating, by the communications device, the grouping rule to a communications peer end by using first indication information; and
the determining, by the communications device, a MIMO target working mode when a MIMO manner is used for inter-antenna port groups comprises:
directly determining, by the communications device, the MIMO target working mode based on channel measurement information, and indicating the MIMO target working mode to the communications peer end by using second indication information.

13. The information transmission method of claim 11, wherein the determining, by the communications device, the number of groups based on the number of overlapping layers comprises:
determining, by the communications device, the number of groups corresponding to the grouping rule in a predefined MIMO working mode configuration table based on the number of overlapping layers; and
after the grouping, by the communications device, antennas, the method further comprises:
determining, by the communications device, a MIMO target working mode corresponding to the number of groups in the predefined MIMO working mode configuration table based on channel measurement information; and
indicating, by the communications device, the MIMO target working mode, and the grouping rule and the number of groups that are corresponding to the MIMO target working mode in the MIMO working mode configuration table to a communications peer end by using third indication information.

14. The information transmission method of claim 1, wherein when the antenna working mode is the FTN mode, the method further comprises:
determining, by the communications device, the number of overlapping layers based on the channel quality; wherein
the performing, by the communications device, information transmission by using the antenna working mode comprises:
superposing, by the communications device, antenna information based on the number of overlapping layers to obtain FTN information; and
transmitting, by the communications device, the FTN information.

15. The information transmission method of claim 14, wherein the method further comprises:
re-determining, by the communications device, the number of overlapping layers in a case that it is determined that a transmission condition is not met, wherein
the transmission condition comprises:
a bit error rate fed back by a communications peer end of the communications device is not less than a first preset threshold; or
the number of packet loss retransmission NACK messages that are sent by a communications peer end and that are received by the communications device reaches a second preset threshold; or
the number of NACK messages that are sent by a communications peer end and that are continuously received by the communications device reaches a third preset threshold; or
an SNR or RSRP of a signal received by the communications device is less than a fourth preset threshold.

16. The information transmission method of claim 15, wherein the method further comprises:
when the antenna working mode is the FTN mode, adjusting, by the communications device, a sending parameter of the FTN information based on antenna measurement information, wherein the antenna measurement information is obtained by measuring an antenna port; and
when the antenna working mode is the MIMO-FTN mode, adjusting, by the communications device, a sending parameter of MIMO-FTN information based on channel measurement information.

17. The information transmission method of claim 16, wherein the method further comprises:
after re-determining the number of overlapping layers, indicating, by the communications device, the re-determined number of overlapping layers to the communications peer end by using fourth indication information; or
after adjusting the sending parameter, indicating, by the communications device, an adjusted sending parameter to the communications peer end by using fifth indication information.

18. The information transmission method of claim 2, wherein when the communications device is a network side device, the method further comprises:
receiving, by the communications device, terminal capability information sent by a terminal, wherein the terminal capability information comprises information indicating whether the terminal supports an FTN decoding algorithm, and the FTN decoding algorithm comprises an uplink FTN decoding algorithm and/or a downlink FTN decoding algorithm.

19. A communications device, comprising:
a processor; and
a memory, storing a program or an instruction that is capable of running on the processor, wherein the program or the instruction, when executed by the processor, causes the communications device to:
obtain channel quality of a plurality of antennas;
determine an antenna working mode according to the channel quality; and
perform information transmission by using the antenna working mode.

20. A non-transitory readable storage medium storing a program or instruction, wherein the program or the instruction, when executed by a processor, causes the processor to:
obtain channel quality of a plurality of antennas;
determine an antenna working mode according to the channel quality; and
perform information transmission by using the antenna working mode.
